(19) United States
(12) Patent Application Publication
(10) Pub. No.: US 2007/0014319 A1
(43) Pub. Date: Jan. 18, 2007

(54) Continuously Tunable External Cavity Diode Laser Sources With High Tuning And Switching Rates And Extended Tuning Ranges

(75) Inventors: Henry A. Hill, Tucson, AZ (US); Steven Hamann, Tucson, AZ (US); Peter Shifflett, Tucson, AZ (US)

Correspondence Address: WILMER CUTLER PICKERING HALE AND DORR LLP, 60 STATE STREET, BOSTON, MA, 02109, US

(73) Assignee: Zetetic Institute, Tucson, AZ (US)

(21) Appl. No.: 11/457,025

(22) Filed: Jul. 12, 2006

Related U.S. Application Data
(60) Provisional application No. 60/699,951, filed on Jul. 15, 2005.
(60) Provisional application No. 60/805,104, filed on Jun. 19, 2006.

(51) Int. Cl. H01S 3/10; H01S 3/08

(52) U.S. Cl. 372/20; 372/102; 372/9

(57) ABSTRACT

An external cavity structure including: a light source for generating a light beam; a dispersive system which in combination with the light source defines a cavity, the dispersive system for directing a selected wavelength of the light beam back into the light source, the dispersive system including a grating for selecting said wavelength of the light beam; and a beam-conditioner positioned within the cavity along a light path between the light source and the dispersive system, the beam conditioner including a beam deflecting element for changing the direction of propagation of the light beam as that light beam that travels between the light source and the dispersive system.

This application claims the benefit of U.S. Provisional Application No. 60/699,951, filed Jul. 15, 2005, and U.S. Provisional Application No. 60/805,104, filed Jun. 19, 2006, both of which are incorporated herein by reference.

### TECHNICAL FIELD

This invention relates to optical beam wavefront measuring interferometry, spectroscopy and high-sensitivity detection of contaminants in gases, and telecommunications applications or coherent optical communications by optical techniques generally implemented with wavelength tunable lasers.

### BACKGROUND OF THE INVENTION

Semiconductor laser diodes typically operate in multiple longitudinal modes, i.e., at multiple frequencies. It is desirable, however, for these lasers in certain applications to operate in a single longitudinal mode over a tunable frequency range to provide single-frequency operation.

Diode lasers have become increasingly important for optical detection of gases (trace gas detection and remote sensing). Typically, high sensitivity detection is achieved with diode lasers by rapidly modulating the laser wavelength across an absorption feature of the target species. By rapidly modulating the laser wavelength, laser intensity noise is dramatically reduced. However, a drawback of using diode lasers used for gas sensing applications is that they operate over a very limited wavelength range. Typically, only one species can be detected with a given laser. The output wavelength range of a diode laser can be extended using an external cavity configuration. With such a configuration, multiple species detection is possible. However, external cavity diode lasers (ECDL) cannot be wavelength modulated at more than a few kHz over an extended frequency range. This inability to provide rapid wavelength modulation over an extended frequency range limits achievable gas detection sensitivity.

A significant portion of optical sources used in telecommunications are continuous wave (CW) single frequency diode lasers. Direct amplitude modulation of these optical sources with injection current is not often utilized in high frequency and long haul applications. Instead, the information encoding on these optical sources is typically added downstream of the laser using electro-optic modulators. At least some embodiments described herein improve upon single frequency continuous wave ECDLs, making them suitable as optical sources for telecommunications.

Typical diode lasers used in telecommunications, particularly those used for dense wavelength division multiplexing (DWDM) applications, are based on distributed feedback (DFB) structures. The DFB structure requires post-growth processing and results in devices an order-of-magnitude more expensive than Fabry-Perot based structures. Although DFB lasers have some temperature and current tuning capability, tuning ranges are limited relative to ECDL designs. An individual DFB laser is suitable for only one DWDM channel. At least some of the embodiments described herein combine the less expensive Fabry-Perot laser structure with other optical components to allow operation at any one of many DWDM channels.

The ECDL described herein is well suited as a back up device for DWDM transmitters. If a primary DFB-driven channel fails, the ECDL can take over until the channel can be repaired. Because the ECDL can operate on many DWDM channels, it can act as a temporary replacement for many DFB lasers. Alternatively, with the present advancement towards dynamically reconfigurable DWDM transmitters, a suite of the ECDLs would be used as primary optical sources. Each ECDL could be configured to operate on any one of many DWDM channels so that channels could be added or dropped based on the real-time bandwidth requirements.

Other telecommunications applications utilizing tunable optical sources of the type described herein also improve on the state of the art. Examples include test and measurement of telecommunications components in the field and during research and development.

Several external cavity configurations have been disclosed for arranging a diffractive grating along with or combined with other reflective elements and other optical elements together with a diode laser establishing an external optical path to insure single longitudinal mode tuning. Examples are shown in FIGS. 1a and 1b. FIG. 1a illustrates a Littrow type external cavity configuration. In this configuration, diode laser 10 with gain media 11 is combined with a rotatable reflective grating element 12, as indicated by arrow 14, via appropriate beam forming optics 16 to provide frequency selection feedback for diode laser 10. FIG. 1b illustrates a Littman-Metcalf type external cavity configuration. In this configuration, diode laser 10 is combined with a fixed reflective element grating 12 and rotatable reflective element 18, as indicated by arrow 20, to form an external cavity and provide frequency selection feedback for diode laser 10.

It is well known that in order to avoid mode hopping between different optical cavity longitudinal modes in an ECDL, the grating angle and/or reflecting element angle of the external cavity grating system or dispersive system and the length of the external cavity must be varied simultaneously so that the cavity longitudinal mode wavelength matches the grating system wavelength. It is also generally known that the effects of a refractive medium in an external cavity alter the simple tuning geometrical configurations for both the Littrow and Littman-Metcalf external cavities.

Compensation for effects of refractive media in the optical path of the external cavity by making modifications of geometrical configurations of ECDLs have been used to compensate for the effects of the index of refraction of the diode laser chip such as noted in an article by F. Favre, D. Le Guen, J. C. Simon, and B. Landousies entitled “External-Cavity Semiconductor Laser With 15 nm Continuous Tuning Range,” Electronic Letters 22, pp 795-796 (1986). However, it is noted that Favre et al. do not explicitly describe the modifications.

Also, compensation for effects of the refractive media by the effects of an independently pumped single mode waveguide section placed in the optical path of the external cavity has been described. The waveguide section could be used as a phase control section in which the amount of current injected into the phase control waveguide section is adjusted to vary the refractive index in the waveguide and thereby effectively offset the effects of the refractive media and control the total optical length of the cavity to minimize mode hopping and extend the tuning range. Such a technique is described by M. Notomi et al. in IEEE Photonics Technology Letters, 2, pp 85-87 (1990).

U.S. Pat. No. 5,319,668 entitled “Tuning System For External Cavity Diode Laser” by Luecke discloses a geometric construction for the location of the pivot point for a Littman-Metcalf configuration shown in FIG. 1b that employs a mirror as the movable element. The construction is carried out in such a way that the deviation of the double pass optical path length from an integer value of wavelengths, termed the “cavity phase error”, is set equal to zero at three distinct wavelengths. This approach requires knowledge of the properties of the optical indices of refraction of all of the materials in the cavity over the tuning range to be used by the ECDL and in particular at the three separate wavelengths. The construction procedure disclosed in U.S. Pat. No. 5,319,668 does not describe or deal with external cavities based on a Littrow configuration, such as shown in FIG. 1a.

U.S. Pat. No. 5,771,252 entitled “External Cavity, Continuously Tunable Wavelength Source” by R. J. Lang, D. G. Mehuys, and D. Welch discloses a geometric construction for the location of a respective pivot point for each of a Littrow and Littman-Metcalf external cavity configurations shown in FIGS. 1a and 1b, respectively. The method disclosed in U.S. Pat. No. 5,771,252 determines the location of a single pivot point for each of the two different cavity configurations such the residual cavity phase error and its first and second derivatives with respect to wavelength are substantially equal to zero at a single wavelength. This approach also requires knowledge of properties of the optical indices of refraction of all of the materials in the cavity over the tuning range to be used by the ECDL and in particular at the single wavelength.

Many different kinds, variations, and improvements have been suggested and disclosed based upon these two configurations for an ECDL, in particular, simplifying optical element alignment, manufacture, and packaging of these ECDLs. An example is the Littman-Metcalf configuration shown in FIG. 1c that involves a rotatable reflective element 18A comprising a Porro prism, e.g., a right angle roof prism, such as disclosed in U.S. Pat. No. 5,771,252. The use of such a reflector simplifies the external cavity alignment of the optical elements. FIG. 1d is another illustration of the Littman-Metcalf configuration with simplified external cavity alignment wherein both reflective element grating 12 and reflective element 18 are rotatable, as indicated by arrow 22, as a unit on a frame or platform 24. FIG. 1e illustrates a Littman-Metcalf platform configuration wherein the light source may be a flared semiconductor amplifier or may be a master oscillator power amplifier (MOPA) 10A. It will be apparent to those skilled in the art that there are many other possible combinations based upon either of the Littrow and Littman-Metcalf configurations.

A commercial ECDL produced by New Focus, Inc., and a similar device is offered by Newport Corporation are based on the Littman-Metcalf grazing incidence design (see M. G. Littman and H. J. Metcalf, Appl. Opt. 17, pp 2224 (1978)). Both instruments employ mechanical movement of a cavity feedback mirror. The maximum wavelength modulation frequency is limited to 2 kHz by the need to move the mirror. Such low modulation frequencies are less effective at reducing the laser “excess” noise that is often the limiting noise source in wavelength modulation absorption measurements of trace gas concentrations. Because of the high dispersion employed in the Littman-Metcalf ECDL design, it is not possible to modulate the laser wavelength by modulating the diode laser injection current or temperature.

Electro-optic effect modulators (EOMs) have been used in an ECDL as phase modulators to modulate the optical path length of the ECDL such as described by A. Schremer and C. L. Tang in an article entitled “Single-frequency Tunable External Cavity Semiconductor Laser Using An Electro-optic Birefringent Modulator,” Applied Physics Lett. 55, pp 19-21 (1989). Also EOMs have been used as phase modulators to generate bistability in an ECDL such as described by T. Fujita, A. Schremer, and C. L. Tang in an article entitled “Polarization Bistability In External Cavity Semiconductor Lasers,” Applied Physics Lett. 51, pp 392-394 (1987). However, neither of these examples use EOMs as beam-deflectors in ECDLs.

U.S. Pat. No. 5,319,668 discloses a geometric construction for the location of the pivot point for a Littman-Metcalf cavity configuration shown in FIG. 1b that employs a mirror as the movable element. The construction is carried out in such a way that the deviation of the double pass path length from an integer value of wavelengths, i.e., the cavity phase error, is set equal to zero at three distinct wavelengths. The geometric construction is indicated to take into account the effects of cavity phase error as a function of wavelength caused by dispersion of optical elements within the light path of the external cavity. Such optical elements are lenses, windows, and the gain media of source 10. The effectiveness of the three position wavelength calculation according to the methods disclosed in U.S. Pat. No. 5,319,668 is illustrated in FIG. 2a for subsequent comparison with performance of certain embodiments of the present invention (see for example FIGS. 4b, 4c, and 4d) which will be discussed in greater detail with the description of respective embodiments. FIG. 2a herein is a reproduction of FIG. 3 in U.S. Pat. No. 5,771,252 wherein the phase error of FIG. 3 has been converted to the cavity phase error in FIG. 2a.

The effectiveness of the method disclosed in U.S. Pat. No. 5,771,252 for the selection of the single pivot point for the movable mirror of a Littman-Metcalf external cavity configuration shown in FIG. 1b is illustrated in FIG. 2b also for subsequent comparison with performance of certain embodiments of the present invention (see for example FIGS. 4c, 4d, and 4e and related description). FIG. 2b herein is a reproduction of FIG. 4 in U.S. Pat. No. 5,771,252 wherein the phase error of FIG. 4 has been converted to the cavity phase error in FIG. 2b.

As will be described below, various embodiments of the present invention use an external cavity design that overcomes the low modulation frequency limitations of present ECDLs and can achieve without mode hoping the high frequency wavelength switching and modulations that are useful for trace gas detection. Those embodiments combine the stability and tunability of an ECDL having an extended tuning range with the wavelength agility of a diode laser and the frequency response of electro-optic effect, photoelastic effect, and acousto-optic modulators. The frequency response without mode hoping for wavelength tuning, switching, and modulation is limited by effective response times of the electro-optic effect, photoelastic effect, and acousto-optic modulators used to change optical path lengths and beam directions and/or the frequency response of properties of a diode laser to rapid changes in injection current. As a consequence, continuous wavelength tuning with switching times in the 10 nanosecond to 1 microsecond regime and corresponding changes in frequencies in the GHz to THz regime are possible. In addition, at least some of the embodiments of the present invention retain the broad wavelength tuning range of commercial instruments.

It is an object of at least some of the embodiments of the present invention to provide an external cavity, continuously tunable wavelength source such as a diode laser device using an external cavity reflective grating, i.e., providing continuous wavelength tuning and switching without longitudinal mode hopping.

It is a further object of at least some of the embodiments of the invention to provide an external cavity, continuously tunable wavelength source such as a diode laser device using an external cavity reflective grating with an extended tuning range.

It is another object of at least some of the embodiments of the invention to provide an external cavity laser that can include dispersive elements; electro-optic effect; photoelastic effect; and acousto-optic effect modulators; rotatable gratings; and rotatable grating, reflector and/or prism combinations that provide continuous single-frequency tuning over extended wavelength bands at corresponding high tuning and switching rates.

It is another object of at least some of the embodiments of the invention to provide a continuously tunable diode laser device with cavity phase error remaining relatively small across the wavelength band of the diode laser.

### SUMMARY OF THE INVENTION

In general, in one aspect, the invention features an external cavity structure including: a light source for generating a light beam; a dispersive system which in combination with the light source defines a cavity, the dispersive system for directing a selected wavelength of the light beam back into the light source, the dispersive system including a grating for selecting said wavelength of the light beam; and a beam-conditioner positioned within the cavity along a light path between the light source and the dispersive system, said beam conditioner including a beam deflecting element for changing the direction of propagation of the light beam as that light beam that travels between the light source and the dispersive system.

Other embodiments include one or more of the following features. The grating is a diffraction grating. The beam deflecting element is for changing the angle of incidence of the light beam onto an element of the dispersive system. The light source and the dispersive system form a Littman-Metcalf type external cavity configuration or alternatively, they form a Littrow type external cavity configuration. The beam-conditioner further includes a phase modulator for shifting the phase of the light beam that travels between the light source and the dispersive system. The external cavity structure also includes a control module for controlling the phase modulator. The grating is a reflective grating. The dispersive system further includes a reflecting element located at a distance from the grating and which is arranged to cooperate with the grating to select the wavelength. The dispersive system has an orientation and position that remain fixed during operation of the external cavity structure. The external cavity structure also includes a control module for controlling the beam deflecting element to change the angle of incidence of the light beam onto an element of the dispersive system. The external cavity structure further includes beam forming optics aligned with the light source for collimating the light beam. The light source is a coherent light source, e.g. a diode laser. The external cavity structure also includes a control module for changing a wavelength profile of the output of the diode laser, e.g. by changing an injection current of the diode laser. The external cavity structure also includes a control module for controlling operation of the beam conditioner. The beam deflecting element includes an acousto-optic effect modulator, or an electro-optic effect modulator, or a photoelastic effect modulator. The phase modulator includes an electro-optic effect modulator or a photoelastic effect modulator.

In general, in another aspect, the invention features a method of operating an external cavity structure that includes a light source and a dispersive system The method involves: at the light source, generating a light beam; sending the light beam along a path from the light source to the dispersive system; at the dispersive system, selecting a particular wavelength of the light beam; directing that selected wavelength back into the light source; and changing the direction of propagation of the light beam as that light beam that travels along that path between the light source and the dispersive system.

Other embodiments include one or more of the following features. Changing the direction of propagation of the light beam involves modulating the direction of the light beam to change the selected wavelength. The method also involves modulating the phase of the light beam as that light beam that travels along said path between the light source and the dispersive system.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1a is a diagrammatic representation of a Littrow external cavity configuration.

FIG. 1b is a diagrammatic representation of a Littman-Metcalf external cavity configuration.

FIG. 1c is a diagrammatic representation of a Littman-Metcalf external cavity configuration with a rotatable reflective element comprising a Porro prism.

FIG. 1d is a diagrammatic representation of a Littman-Metcalf external cavity configuration with the grating and reflective element located on a platform that is rotatable as a unit.

FIG. 1e is a diagrammatic representation of a Littman-Metcalf external cavity configuration with a flared semiconductor amplifier as a source.

FIG. 2a is a graphical representation of the residual cavity phase error across the tuning wavelength range of an external cavity, continuously tunable wavelength source in accordance with the three pivot point approach disclosed in U.S. Pat. No. 5,319,668.

FIG. 2b is a graphical representation of the residual phase error across the tuning wavelength range of an external cavity, continuously tunable wavelength source in accordance with the single pivot point location of an external cavity disclosed in U.S. Pat. No. 5,771,252.

FIG. 3a is a diagrammatic representation of an ECDL based on a Littrow cavity configuration with beam-deflectors and phase modulators located in the intra-cavity beam path of the respective external cavity.

FIG. 3b is a diagrammatic representation of an ECDL based on a Littman-Metcalf cavity configuration with beam-deflectors and phase modulators located in the intra-cavity beam path of the respective external cavity.

FIG. 3c is a diagram of a Littrow external cavity ECDL.

FIG. 3d is a diagram of a Littman-Metcalf external cavity ECDL.

FIG. 4a is a diagrammatic representation of an ECDL based on a Littman-Metcalf cavity configuration with a prism used as beam-deflector located in the intra-cavity beam path of the respective external cavity.

FIG. 4b is a diagrammatic representation of an ECDL based on a Littman-Metcalf cavity configuration with prisms used as beam-deflectors located in the intra-cavity beam path of the respective external cavity.

FIG. 4c is a graphical representation of the cavity phase error across the tuning wavelength range of an external cavity, continuously tunable wavelength source wherein the effects of elements in the cavity of an ECDL, e.g., beam forming optical elements, comprising a BK7 medium is compensated.

FIG. 4d is a graphical representation of the cavity phase error across the tuning wavelength range of an external cavity, continuously tunable wavelength source wherein the effects of elements in the cavity of an ECDL, e.g., birefringent crystals used in EOMs, comprising a LiNbO₃ medium is compensated.

FIG. 4e is a graphical representation of the cavity phase error across the tuning wavelength range of an external cavity, continuously tunable wavelength source wherein the effects of elements in the cavity of an ECDL, e.g., a gain medium used in a diode laser source, comprising AlAs is compensated.

FIG. 5a is a diagrammatic representation of an electro-optic effect modulator configured as a beam-deflector.

FIG. 5b is a diagrammatic representation of an electro-optic effect modulator configured with combined functions of a phase-shifter and beam-deflector.

FIG. 5c is a diagrammatic representation of an electro-optic effect modulator configured with combined functions of a phase-shifter and beam-deflectors.

FIG. 5d is a diagrammatic representation of cross-section of a photoelastic effect modulator configured as a phase-shifter.

FIG. 6a is a diagrammatic representation of an ECDL based on a Littrow external cavity using electro-optic effect beam-deflectors and grating in a monolithic slab waveguide configuration.

FIG. 6b is a diagrammatic representation of a monolithic slab waveguide comprising electro-optic effect beam-deflectors and grating.

FIG. 6c is a diagrammatic representation of a monolithic slab waveguide comprising electro-optic effect beam-deflectors and grating.

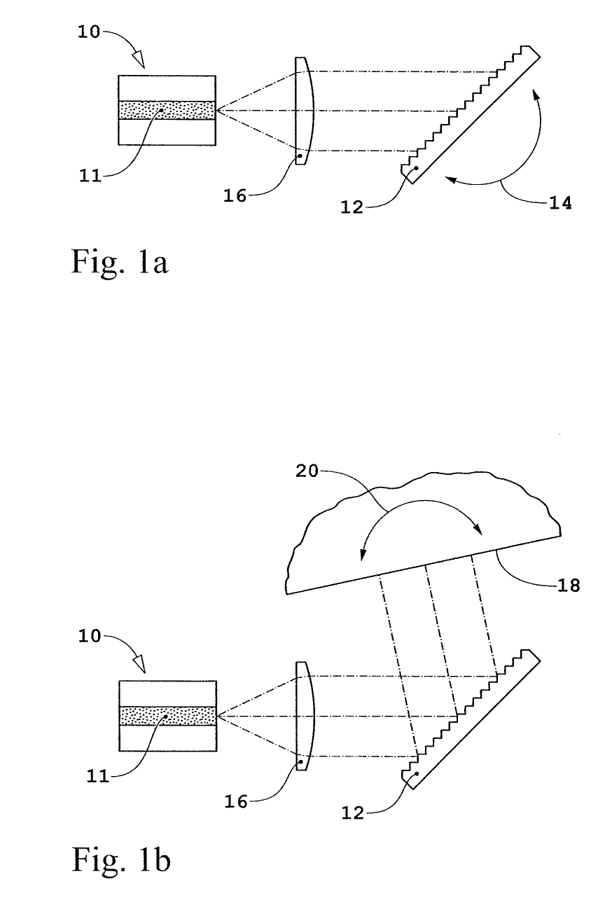

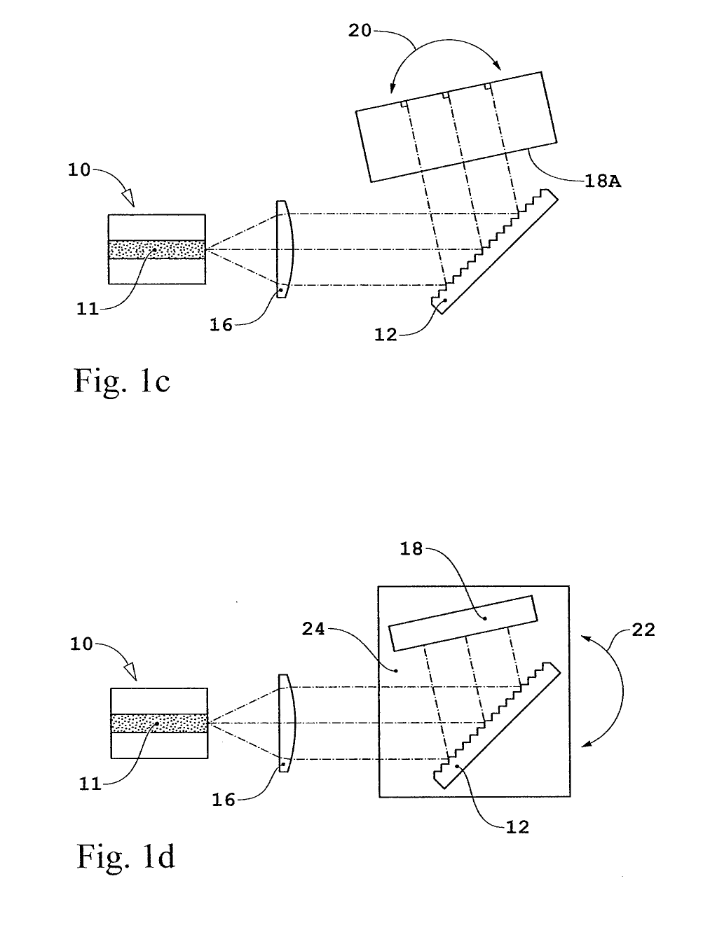

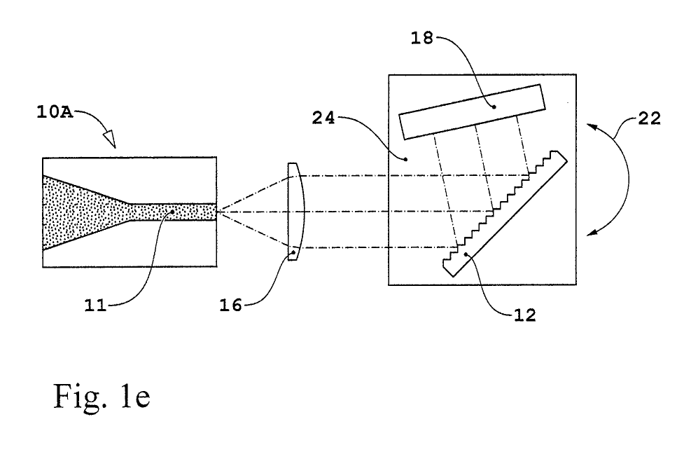

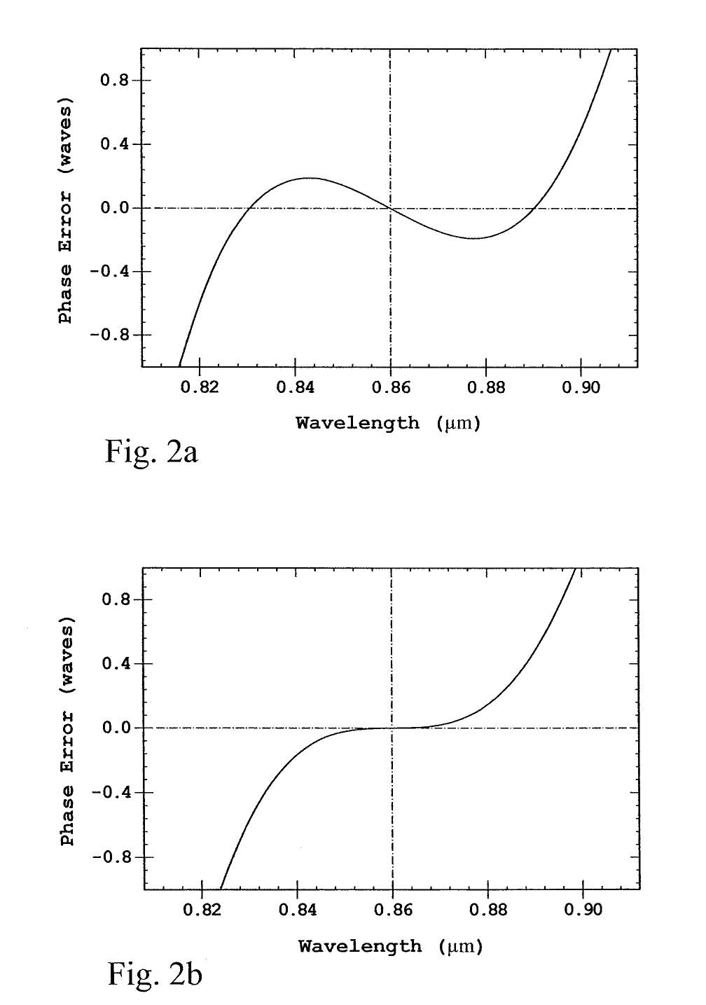

### DETAILED DESCRIPTION

A continuously tunable external cavity source is disclosed that comprises a coherent light source, a dispersive system, and a beam-conditioner. The intra-cavity beam conditioner comprises beam deflecting and phase shifting elements. The dispersive system directs a selected wavelength from the coherent light source back into the coherent light source by either diffraction and/or refraction. Two features of an external cavity comprising a dispersive system is a first order sensitivity of the order of interference of the external cavity to the wavelength of the selected wavelength and a first order sensitivity of the wavelength of the selected wavelength to changes in the direction of propagation of a beam incident on a dispersive element of the dispersive system. Various embodiments of the present invention exploit both of these features to obtain continuously tunable external cavity diode laser sources with high tuning and switching rates and extended tuning ranges in comparison to prior art.

The dispersive system may comprise one or more reflectors or Porro prisms in addition to a grating and/or dispersive prism. The wavelength of the selected wavelength is changed by making simultaneous changes in the angle of incidence of an external cavity beam on an element of the dispersive system and in the double pass optical path length of the external cavity such that the order of interference is substantially identical to a integer value, i.e., the double pass optical path length is substantially identical to a integer value of wavelengths of the selected wavelength, over the tunable wavelength range of the external cavity source. Simultaneous with the changes in the two properties of the external cavity, changes are made in the wavelength profile of the output of the associated diode laser by changing the injection current of the associated diode laser in order that the wavelength profile track the properties of the external cavity.

The change in the angle of incidence of the external cavity beam may comprise a change in the direction of propagation of the external cavity beam or a change in the orientation of a grating, dispersive prism, and/or reflecting element or elements of the dispersive system, or a combination thereof. The change in the double pass optical path length of the external cavity may comprise a change in the optical path length of a dispersive element in the path of the external cavity beam or a change in the location of the dispersive system or a combination thereof.

The optical path effects of optical media in the optical path of the external cavity are compensated in various embodiments of the present invention by making changes in the wavelength of the selected wavelength or compensated as an integral part of techniques used to make changes in the wavelength of the selected wavelength. The changes in the angle of incidence of the external cavity beam and changes in the double pass optical length of the external cavity are made by use of a beam-conditioner comprising one or more dispersive elements, electro-optic effect modulators used as electro-optic effect phase modulators and electro-optic effect beam-deflector modulators, photoelastic effect modulators used as photoelastic effect phase-modulators and photoelastic effect beam-deflector modulators; and acousto-optic effect modulators used as acousto-optic effect beam-deflectors. The external cavity may be either of a Littman-Metcalf optical cavity configuration or a Littrow cavity configuration or some other external cavity comprising a dispersive system. The output of the external cavity source may be optically coupled to a gain element for amplification.

The response times for frequency tuning and switching and corresponding ranges of frequency tuning and switching without mode hoping are determined by the properties of elements used to generate the changes in the angle of incidence of an external cavity beam on an element of the dispersive system and changes in the double pass optical length of the external cavity and/or the frequency response of properties of a diode laser to rapid changes in injection current. For examples of three beam-conditioner embodiments based on electro-optic effect modulators operating with a central wavelength of 700 nm, performances are achieved with average response times for frequency changes without mode hoping of the order of 12, 18, and 39 nsec with a maximum tuning or switching ranges of the order of 10 GHz, 100 GHz, and 600 GHz, respectively. For examples of beam-conditioner embodiments based on photoelastic effect modulators operating with a central wavelength of 700 nm, performances are achieved with average response times for frequency changes without mode hoping of the order of 250 nsec with a maximum tuning or switching range of the order of 1 THz.

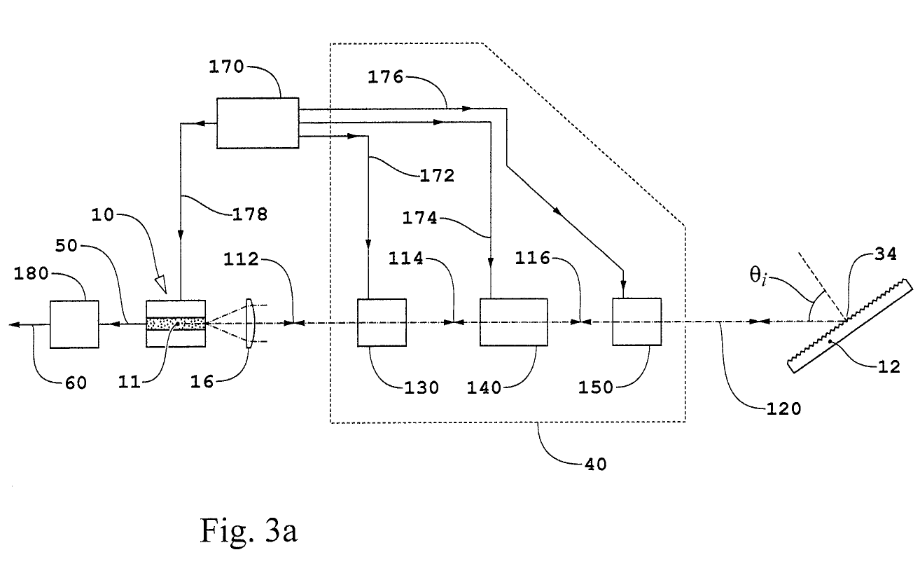

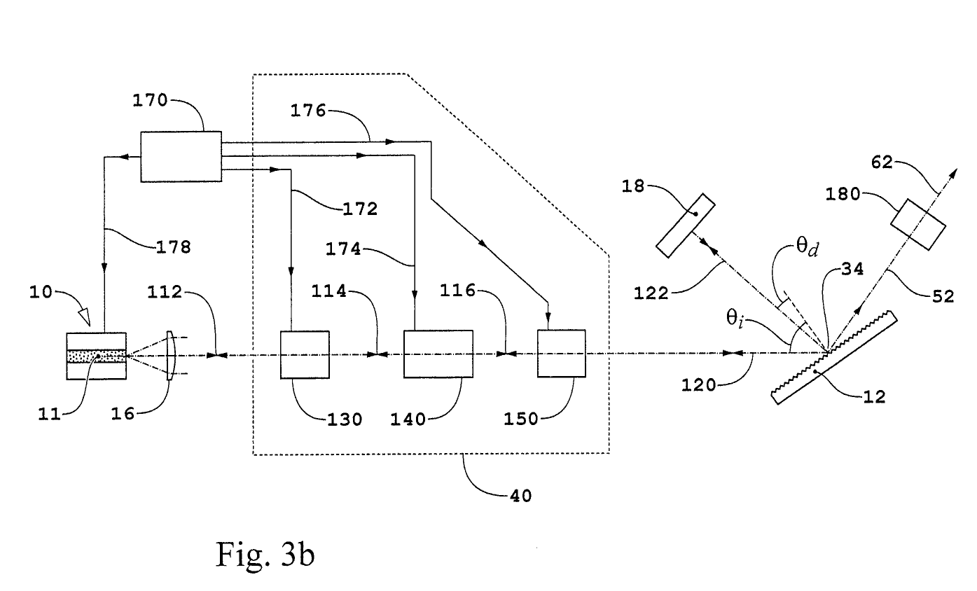

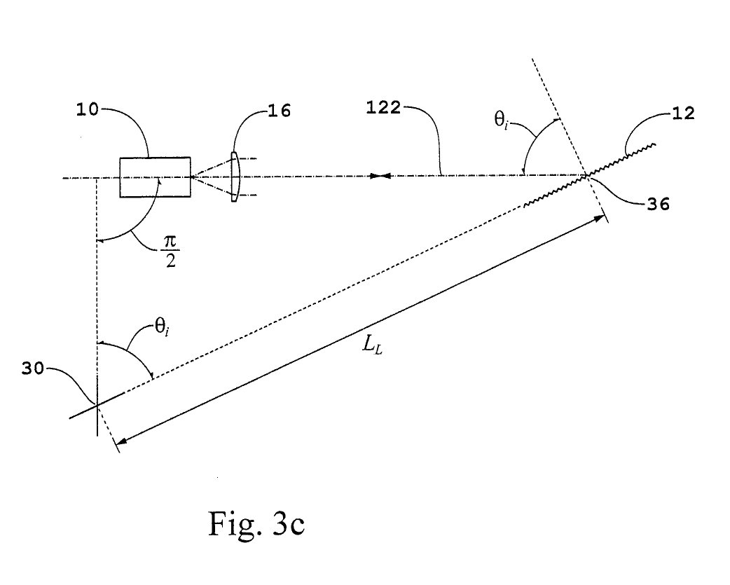

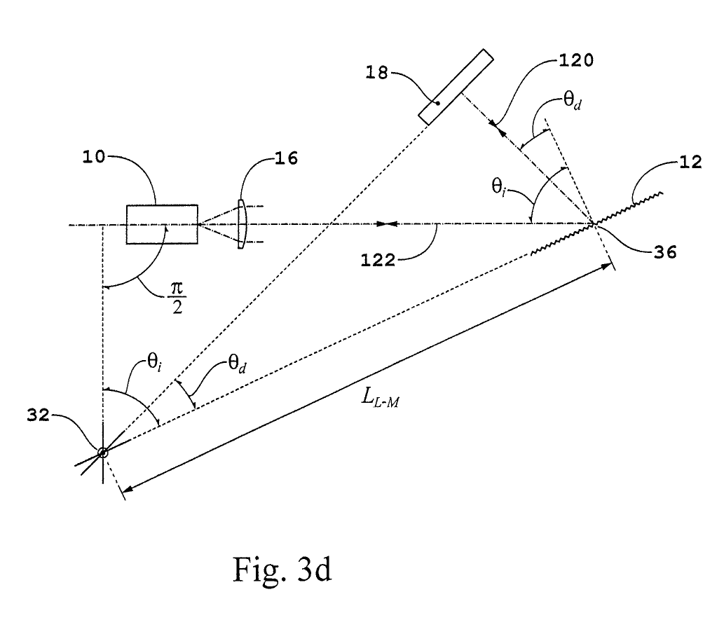

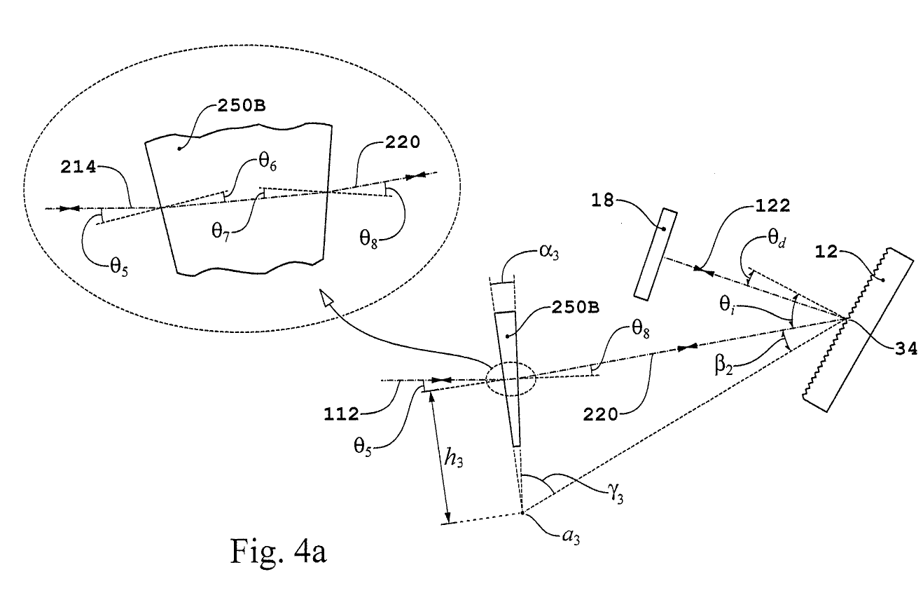

The relationship between the angles incidence θᵢ and diffraction θ_{d}, the wavelength λ, and the grating line spacing Λ for a grating of the dispersive system diffracting in order m is given for the Littman-Metcalf external cavity by the formula
mλ=Λ(sin θᵢ+sin θ_{d}) (Littman-Metcalf external cavity). (1)
The angles θᵢ and θ_{d} are indicated in FIG. 3b for the Littman-Metcalf external cavity. For a Littrow external cavity, the angles of incidence and diffraction are equal (see FIG. 3a) and the corresponding grating formula reduces to the formula
mλ=2Λ sin θᵢ(Littrow external cavity). (2)

The double pass optical path length for the external cavities must also be an integer value of wavelength λ. The double pass optical path length for the Littrow external cavity and the Littman-Metcalf external cavity are given by the formulae
OPL₁=2L_{L} sin θᵢ(Littrow external cavity). (3)
OPL₂=2L_{L-M}(sin θᵢ+sin θ_{d}) (Littman-Metcalf external cavity). (4)
where L_{L} and L_{L-M} are defined in FIGS. 3c and 3d, respectively.

When there are no dispersive elements in the optical path of the respective external cavities, it is evident from inspection of Eqs. (1), (2), (3), and (4) that one or a first class of solutions for continuous tuning of the respective ECDLs can be achieved when the values of L_{L} and L_{L-M} are constants independent of the values of the angles of incidence θᵢ and diffraction θ_{d}. The requirement that the value of L_{L} be kept constant can be met by coordinated translations of point 36 alone the axis 122 defined by the optical path in the external cavity and of point 30 along a path perpendicular to axis 122 that intersects axis 122 at a cavity reflector located to the left of source 10. The requirement that the value of L_{L-M} be kept constant can be met by rotating reflector 18 about the point 32 that is located as shown in FIG. 3d.

However, the presence of the refractive or dispersive gain media of source 10 limits the tuning range that can be achieved by the first class of solutions such as described and addressed in U.S. Pat. Nos. 5,319,668 and 5,771,252. Reducing the effects of the refractive media of source 10 in U.S. Pat. No. 5,771,252 is achieved by the selection of a single pivot point different from point 32 and achieved in the case of U.S. Pat. No. 5,319,668 using a set of three pivot points in lieu of point 32.

Also the first class of solutions requires the rotation and/or translation of optical elements which places limits of the rate of tuning that can be achieved.

A second class of solutions is used in certain embodiments of the present invention. The second class of solutions is based on the coordinated introduction by a beam-conditioner of changes in the angle of incidence of an intra-cavity beam of the ECDL incident on the dispersive element of the dispersive system and changes in the external cavity optical path length. A general description of those embodiments of the present invention is presented based on the second class of solutions and the ECDL configurations shown diagrammatically in FIGS. 3a and 3b.

The external cavities shown in FIGS. 3a and 3b are of the Littrow and Littman-Metcalf type external cavities, respectively. The ECDLs comprise grating 12 for the Littrow configuration and grating 12 and reflector 18 for the Littman-Metcalf configuration. The ECDLs further comprise laser source 10, e.g., a diode laser gain media 11, beam forming optics 16, and beam-conditioner 40. The output beams for the Littrow and Littman-Metcalf type cavity configurations are beams 50 and 52, respectively, which may be incident on beam-conditioners 180 and exit as beams 60 and 62, respectively.

Source 10 and beam forming optics 16 generate an intra-cavity collimated beam as a component of beam 112. The component of beam 112 is incident on beam-conditioner 40 and a portion thereof is transmitted as a deflected and phase-shifted beam component of beam 120.

For the Littrow cavity configuration shown in FIG. 3a, a portion of the deflected and phase-shifted component of beam 120 is diffracted as a diffracted component of beam 120. For the Littman-Metcalf cavity configuration shown in FIG. 3b, a portion of the deflected and phase-shifted component of beam 120 is diffracted as a diffracted component of beam 122 which is subsequently reflected by reflecting element 18 as a reflected, diffracted component of beam 122. A portion of the reflected, diffracted component of beam 122 is subsequently diffracted as a diffracted component of beam 120. The diffracted component of beam 122 is incident on reflecting element 18 with a zero value for the angle of incidence. Reflecting element 18 may comprise a single reflecting surface or more than a single reflecting surface such as a Porro prism which simplifies the alignment of the external cavity.

The path of the diffracted beam component of beam 120 through the external cavities of FIGS. 3a and 3b to source 10 coincides with the components of the intra-cavity beam components propagating to the right in FIGS. 3a and 3b. A portion of diffracted beam component of beam 120 incident on source 10 is double passed by the cavity of source 10 after reflection by a reflector on the left side of source 10. The double passed beam corresponds to the component of collimated beam component of beam 112.

For the Littrow cavity configuration shown in FIG. 3a, a second portion of the diffracted beam component of beam 120 incident on source 10 is transmitted by the reflector on the left side of source 10 as output beam 50. For the Littman-Metcalf cavity configuration shown in FIG. 3b, a second portion of the deflected and phase-shifted beam component of beam 120 incident on grating 12 is reflected in the zeroth order of grating 12 as output beam 52. Output beams 50 and 52 may subsequently be passed through beam-conditioners 180 to for example amplify the beam intensities, the spatial properties of beams, or change the respective beam directions of propagation to form beams 60 and 62, respectively.

Certain embodiments of beam-conditioner 40 comprise beam-deflectors 130 and 150, phase-shifter 140, and electronic processor and controller 170. Certain other embodiments of beam-conditioner 40 may comprise a different number of beam-deflectors and phase modulators such as subsequently described with respect to certain embodiments of the present invention. The net deflection 0 of the deflected and phase-shifted component of beam 120 is
θ=\tilde{θ}₁+\tilde{θ}₂ (5)
where \tilde{θ}₁ and \tilde{θ}₂ are the beam deflections introduced by beam-deflectors 130 and 150, respectively. Beam-conditioner 40 is configured such that the lateral shear of deflected and phase-shifted component of beam 120 at position 34 (see FIGS. 3a and 3b) on grating 12 is independent of the values of \tilde{θ}₁ and \tilde{θ}₂ to a predetermined value, e.g., less than a fraction of the grating spacing A times the cosine of the respective angle of incidence θᵢ, in order that there be no mode hoping.

The double pass path lengths OPL₁ and OPL₂ for the Littrow and Littman-Metcalf cavities, respectively, are expressed as
OPL₁=2[l₀n₀+lₛ(nₛ−n₀)+lₗ(n₁−n₀)+OPD_{BC}], (6)
OPL₂=2[l₀n₀+lₛ(nₛ−n₀)+lₗ(nₗ−n₀)+OPD_{BC}+Ln₀ sin θ_{d}], (7)
respectively, where l₀ and n₀ are the physical path length and index of refraction, respectively, of the optical path in the source 10-grating 12 section of the respective external cavity with n₀≅1, e.g., such as that of air, excluding contributions of source 10, lens 16, and beam conditioner 40; lₛ and nₛ are the physical path length and index of refraction of source media 11, respectively; lₗ and nₗ are the physical path length and index of refraction of lens 16, respectively; OPD_{BC} is the optical path difference introduced by beam-conditioner 40; and Ln₀ sin θ_{d} is the optical path length for the grating 12-reflector 18 section for the Littman-Metcalf configuration.

The double pass path lengths OPL₁ and OPL₂ exhibit a first order dependence on λ through the wavelength dependence of nₛ, nₗ, and OPD_{BC}.

The operation of beam-deflectors 130 and 150 and phase-modulator 140 are controlled by signals 172, 174, and 176, respectively, that are generated by electronic processor and controller 170. The injection current of source 10 is controlled by signal 178 which is also generated by electronic processor and controller 170.

The corresponding grating formulae are expressed as
mλ=2Λ sin θᵢ(Littrow external cavity), (8)
mλ=Λ(sin θᵢ+sin θ_{d}) (Littman-Metcalf external cavity). (9)
The right hand sides of Eqs. (8) and (9) also exhibit a first order dependence on \tilde{θ}₁ and \tilde{θ}₂ since θᵢ is in part determined by \tilde{θ}₁ and \tilde{θ}₂.

As a consequence of the properties of the different terms in corresponding Eqs. (6) and (8) and in corresponding Eqs. (7) and (9) and/or as a consequence of the independent control of the beam deflections \tilde{θ}₁ and \tilde{θ}₂ and the phase shifts introduced by beam-conditioner 40, there are in general solutions giving the beam deflections as functions of wavelength λ for which ratios of respective double pass optical path lengths and wavelength λ given by corresponding grating formulae are integer values without mode hoping over an extended tuning range.

External Cavities with Dispersive Prism Elements Configured as Passive Beam-Deflectors

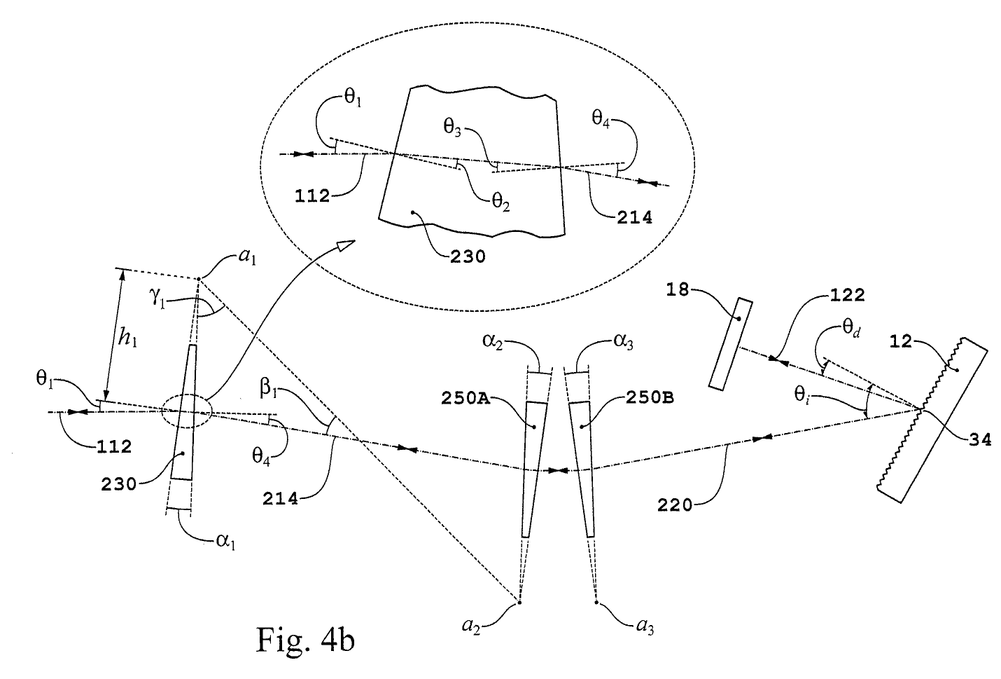

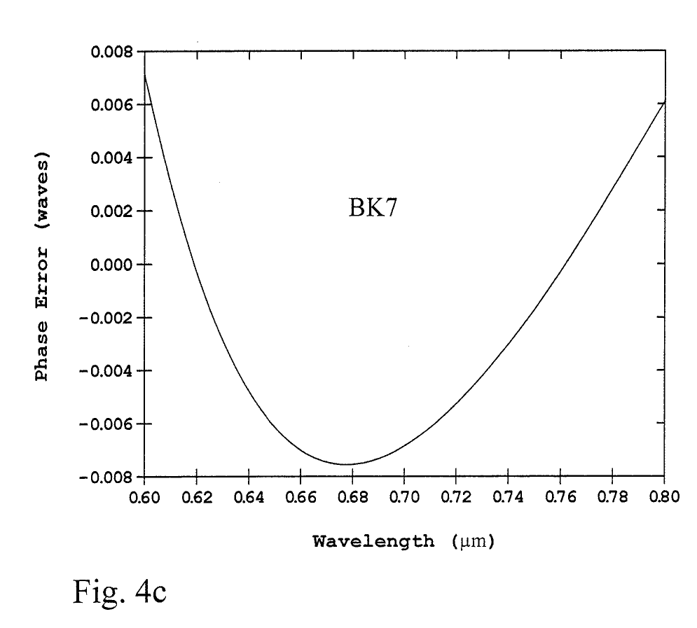

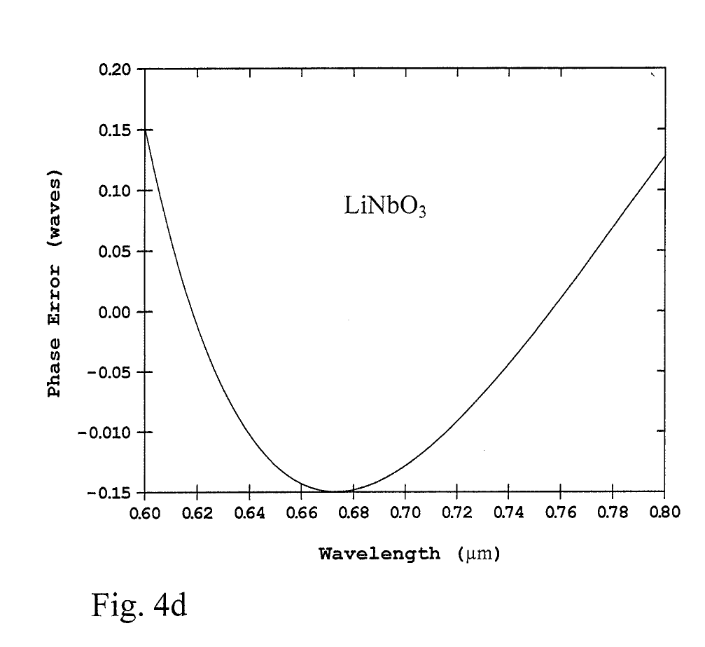

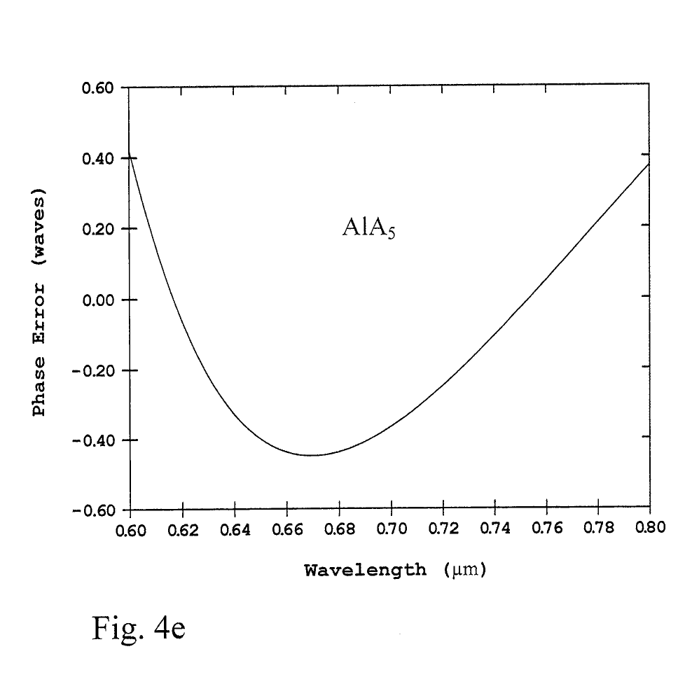

The first embodiment of the present invention is based on use of a dispersive prism element to compensate for the effect of dispersive elements in an ECDL such as a source medium. For the first embodiment, beam-conditioner 40 comprises beam-deflector 150 configured as a dispersive prism element without beam-deflector 130 and phase-modulator 140 in a Littman-Metcalf external cavity. Beam-deflector 150 comprises a single prism 250B (see FIG. 4a). The optical path length OPL₂ of the Littman-Metcalf external cavity can be written in a simple form as

$${OPL}_{2} = 2 \{ \begin{matrix}{l}_{0} {n}_{0} + {l}_{s} ( {n}_{s} - {n}_{0} ) + {L}_{2} {n}_{0} [ cos {β}_{2} - cos ( \frac{π}{2} + {θ}_{5} - {α}_{3} - {γ}_{3} ) ] \\ + {L}_{L - M} {n}_{0} sin {θ}_{d}\end{matrix} \} , \qquad ( 10 )$$

where α₃ and n₃ are the apex angle and index of refraction of prism 250B; angle β₂ is the angle between beam 220 and the line joining apex a₃ and point 34 on grating 12; γ₃ is the angle between the line joining apex a₃ and point 34 on grating 12 and the adjacent facet of prism 250B (see FIG. 4a); O₅ in the angle of incidence/refraction for beam 112 at the corresponding facet of prism 250B (see exploded section of FIG. 4a); and L₂ is the distance between apex a₃ and point 34 on grating 12. The parameter h₃ shown in FIG. 4a is the distance parallel to the beam 112 entrant/exit facet of prism 250B between apex a₃ and the location of beam 112 at corresponding entrant/exit facet of prism 250B.

If the media of dispersive prism 250B is selected to be the same as the dispersive media of source 10, i.e., n₃=nₛ, the effects of the refractive media of source 10 can be compensated to a high order for the Littman-Metcalf external cavity. The effect of the compensation is to achieve a tuning range with a reduced restriction introduced by the presence of the dispersive media in source 10.

Three different designs of the first embodiment are presented wherein the effects of three different media located in the respective external cavities are compensated. The three different media are BK7, LiNbO₃, and AlAs. BK7 is a glass commonly used in lenses such as the beam forming optic 16, birefringent LiNbO₃ is a candidate for the medium used in EOMs, and AlAs is a medium similar to the gain medium with respect to index of refraction used in certain diode lasers. The parameters specific to the three different designs for the Littman-Metcalf ECDL are listed in Table 1 for the three different media. Corresponding values of length L₂ and angle γ₃ used in the three different designs are listed in columns 4 and 5, respectively. The grating line spacing used in the three different designs is Λ=1000 nm and the order of interference assumed for the ECDL is 2×10⁵.

TABLE 1
Littman-Metcalf ECDL With A Passive Prism Beam-Deflector

| | n | α₃ | L₂ | | l_{c} |
|---|---|---|---|---|---|
| Medium | at 700 nm | radians | mm | γ₃ | mm |
| BK7 | 1.51307 | 0.140 | 12 | 0.86 | 8.987 |
| LiNbO₃ | 2.18947 | 0.100 | 13 | 0.70 | 6.207 |
| | (nₑ) | | | | |
| AlAs | 3.05658 | 0.042 | 23 | 0.50 | 2.161 |

The sixth column of Table 1 lists the single pass physical path length l_{c} for the three different media compensated in the external cavity in addition to the compensation for the single pass physical path length in the three different prisms.

The compensated path lengths l_{c} are large enough to cover for example the physical path length associated beam forming optics comprising BK7. With a typical length of a gain medium in a diode laser of 0.5 mm, the compensated path length for a similar medium is also large enough to compensate for an associated gain medium of a diode laser.

The thicknesses of prism 250B at the location of beam 112 at entrant/exit facet of prism 250B are 0.96 mm, 0.90 mm, and 0.81 mm for the three different designs that have media BK7, LiNbO₃, and AlAs, respectively.

Cavity phase errors are presented graphically in FIGS. 4c, 4d, and 4e in terms of fractions of the respective wavelength over an extended tuning range of ±100 nm at a central wavelength of 700 nm for the three different designs. The effectiveness in compensating for effects of dispersive media located in the intra-cavity of an external cavity are evident on comparison of the results shown FIGS. 4c, 4d, and 4e with the results shown in FIGS. 2a and 2b. Note the extended range of tuning and the reduced range of values of cavity phase errors as represented in FIGS. 4c, 4d, and 4e of the first embodiment of the present invention in comparison to the corresponding properties represented in FIGS. 2a and 2b.

There are other solutions wherein the effects of the dispersion of media in an external cavity are beneficially compensated. The degree of compensation of these other solutions which may better than or not be as good as the solutions represented by the three different solutions can be of sufficient value to relax the restrictions on n₃ relative to nₛ.

The direction of propagation of output beam 52 of the Littman-Metcalf external cavity (see FIG. 3b) will change as a function of the selected wavelength of the respective ECDL. The change in direction of propagation is a consequence of the change in angle of incidence θᵢ on grating 12 generated by beam-deflector 250B. The change in direction of propagation of output beam 52 may be compensated with beam-conditioner 180 comprising a dispersive prism of the same type as prism 250B.

A first variant of the first embodiment of the present invention is described for use when it is desirable to compensate for beam shear at grating 12 such as generated by the dispersive properties of prism 250B in the first embodiment in addition to compensation for the effects of dispersive elements in the intra-cavity of an ECDL. For the first variant of the first embodiment, beam-conditioner 40 comprises beam-deflectors 130 and 150 configured as dispersive prism elements without phase modulator 140 in a Littman-Metcalf external cavity. Beam-deflector 130 comprises a single prism 230 and beam-deflector 150 comprises two prisms 250A and 250B instead of a single prism element in order to reduce the size of second order effects (see FIG. 4b). For the case where prisms 230, 250A, and 250B are identical, the angles of incidence/refraction of the intra-cavity beam between prisms 250A and 250B at the intra-cavity beam entrant/exit facets of prisms 250A and 250B are equal to angle θ₁, optical path length OPL₂ for the Littman-Metcalf external cavity can be written without in a simple form as

$${OPL}_{2} = 2 \{ \begin{matrix}{l}_{0} {n}_{0} + {l}_{s} ( {n}_{s} - {n}_{0} ) + 2 {L}_{1} {n}_{0} [ cos {β}_{1} - cos ( \frac{π}{2} + {θ}_{1} - {α}_{1} - {γ}_{1} ) ] \\ - {h}_{1} [ {n}_{1} \frac{sin {α}_{1}}{cos {θ}_{3}} = \frac{sin ( \frac{{α}_{1}}{2} ) cos {θ}_{2}}{cos {θ}_{3} cos ( {θ}_{4} - \frac{{α}_{1}}{2} )} ] - x \frac{cos ( {θ}_{1} - \frac{{α}_{1}}{2} )}{cos ( {θ}_{4} - \frac{{α}_{1}}{2} )} \\ + {L}_{L - M} {n}_{0} sin {θ}_{d}\end{matrix} \} , \qquad ( 11 )$$

where α₁ and n₁ are the apex angle and index of refraction of the prism 230; h₁ is the distance parallel to the beam 112 entrant/exit facet of prism 230 between apex a₁ and the location of beam 112 at beam 112 entrant/exit facet of prism 230; angle β₁ is the angle between beam 214 and the line joining apexes a₁ and a₂; γ₁ is the angle between the line joining apexes a₁ and a₂ and the beam 214 entrant/exit facet of prism 230 (see FIG. 4b); L₁ is the distance between apexes a₁ and a₂; and x is the location in the direction defined by beam 112 of the stationary point for beam 220 from the axis of a conjugate image of the axis of prism 230. The stationary point is used as point 34 on grating 12. Angles θ₁, θ₃, and θ₄ are defined in the exploded section of FIG. 4b. The conjugate image is the image that would be generated by a mirror placed halfway in between prisms 250A and 250B. The stationary point corresponds to a position on the path of beam 220 that is stationary with respect to changes in wavelength λ, i.e., a point where there is no lateral shear introduced by a change in wavelength λ.

If the media of dispersive prisms 230, 250A, and 250B are selected to be the same as the dispersive media of source 10, i.e., n₁=n₂=n₃=nₛ, where n₂ and n₃ are the refractive indices for prisms 250A and 250B, respectively, the effects of the refractive media of source 10 can be compensated to a high order for the Littman-Metcalf cavity. The effect of the compensation is to achieve a tuning range with a reduced restriction introduced by the presence of the dispersive media in source 10.

Three different designs of the first embodiment are presented wherein the effects of three different media located in the respective external cavity are compensated. The three different media are BK7, LiNbO₃, and AlAs which are the same media used is demonstrating properties of the first embodiment. The parameters specific to the three different designs for the first variant of the first embodiment are listed in Table 2 for the three different media for the Littman-Metcalf ECDL. Corresponding values of length L₁ and angle γ₁ used in the three different designs are listed in columns 4 and 5, respectively. The grating line spacing used in the three different designs is Λ=1000 nm and the order of interference assumed for the ECDL is 2×10⁵. The sixth column of Table 2 lists the single pass physical path length l_{c} of the three different media compensated in the external cavity in addition to the compensation for the single pass physical path length in the three different prisms.

The compensated path lengths l_{c} are large enough to cover for example the physical path length associated with beam forming optics comprising BK7. With a typical length of a gain medium in a diode laser of 0.5 mm, the compensated path length for a similar medium is also large enough to compensate for an associated gain medium of a diode laser.

The thicknesses of prisms 230, 250A, and 250B are the same as the thicknesses of prism 250B of the first embodiment for the three different designs that have media BK7, LiNbO₃, and AlAs.

The difference between corresponding values of l_{c} in Tables 1 and 2 is twice the thickness of a single prism for the three different designs that have media BK7, LiNbO₃, and AlAs.

Cavity phase errors are the same to the order of or less than a percent as the cavity errors presented graphically in FIGS. 4c, 4d, and 4e for the first embodiment of the present invention. The cavity phase errors are presented in terms of fractions of the respective wavelength over an extended tuning range of ±100 nm at a central wavelength of 700 nm for the three different designs. The effectiveness

TABLE 2
Littman-Metcalf ECDL With Passive Prism Beam-Deflectors: Zero Beam
Shear

| | n | α₁ | L₁ | | l_{c} |
|---|---|---|---|---|---|
| Medium | at 700 nm | radians | mm | γ₁ | mm |
| BK7 | 1.51307 | 0.140 | 24 | 0.86 | 7.139 |
| LiNbO₃ | 2.18947 | 0.100 | 26 | 0.70 | 4.403 |
| | (nₑ) | | | | |
| AlAs | 3.05658 | 0.042 | 46 | 0.50 | 0.540 |

in compensating for effects of dispersive media located in the intra-cavity of an external cavity are evident on comparison of the results shown FIGS. 4c, 4d, and 4e with the results shown in FIGS. 2a and 2b. Note the extended range of tuning and the reduced range of values of cavity phase errors as represented in FIGS. 4c, 4d, and 4e in comparison to the corresponding properties represented in FIGS. 2a and 2b.

There are other solutions wherein the effects of the dispersion of media in an external cavity are beneficially compensated. The degree of compensation of these other solutions which may be better or not as good as the solutions represented by the three different solutions can be of sufficient value to relax the restrictions on n₁, n₂, and n₃ relative to nₛ.

The direction of propagation of output beam 52 of the Littman-Metcalf external cavity will change as a function of the selected wavelength of the respective ECDL (see FIG. 3b). The change in direction of propagation is a consequence of the change in angle of incidence θᵢ on grating 12 generated by beam-deflectors 230, 250A, and 250B. The change in direction of propagation of output beam 52 may be compensated with beam-conditioner 180 comprising a dispersive prism of the same type as prisms 230, 250A, and 250B.

External Cavities With Phase-Shifters And Beam-Deflectors Based On Electro-Optic Effect

A second embodiment of the present invention is described that is based on use of electro-optic effect in a beam-conditioner to generate frequency changes in the output beam of an ECDL. For the second embodiment, beam-conditioner 40 comprises phase-modulator 140 and beam-deflector 150 in a Littman-Metcalf external cavity.

Electro-Optic Effect Beam-Deflector

Reference is made to Section 8.1.2 entitled “Transverse Electro-Optic Modulators” in the book Optical Waves In Crystals by A. Yariv and P. Yeh (Wiley 1984) for a discussion of electro-optic effect modulators. Also reference is made to Section 8.6 entitled “Electro-Optic Beam Deflection”, Yariv and Yeh, op. cit., for a discussion of electro-optic effect beam-deflectors. The contents of the referenced book by Yariv and Yeh are herein incorporated in their entirety by reference.

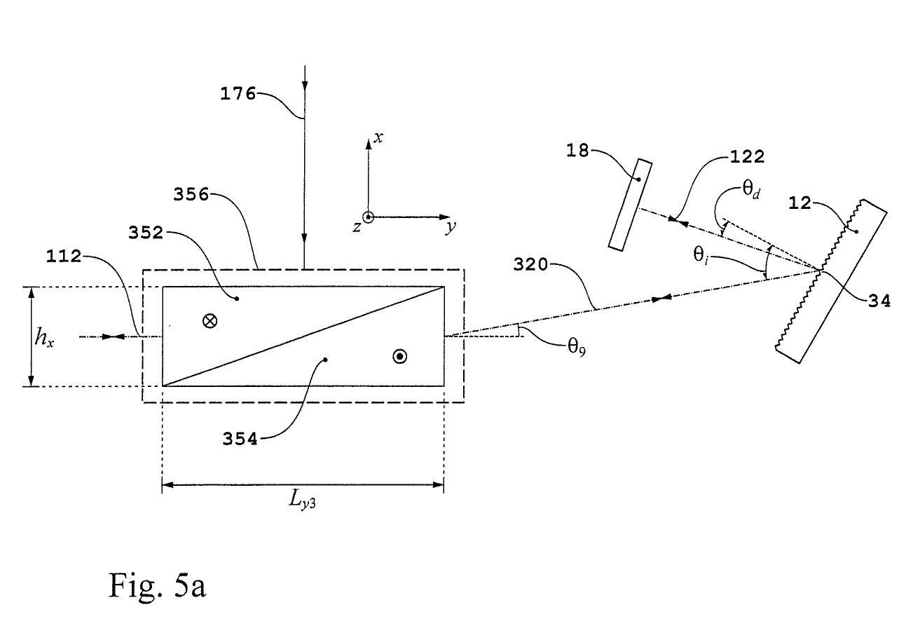

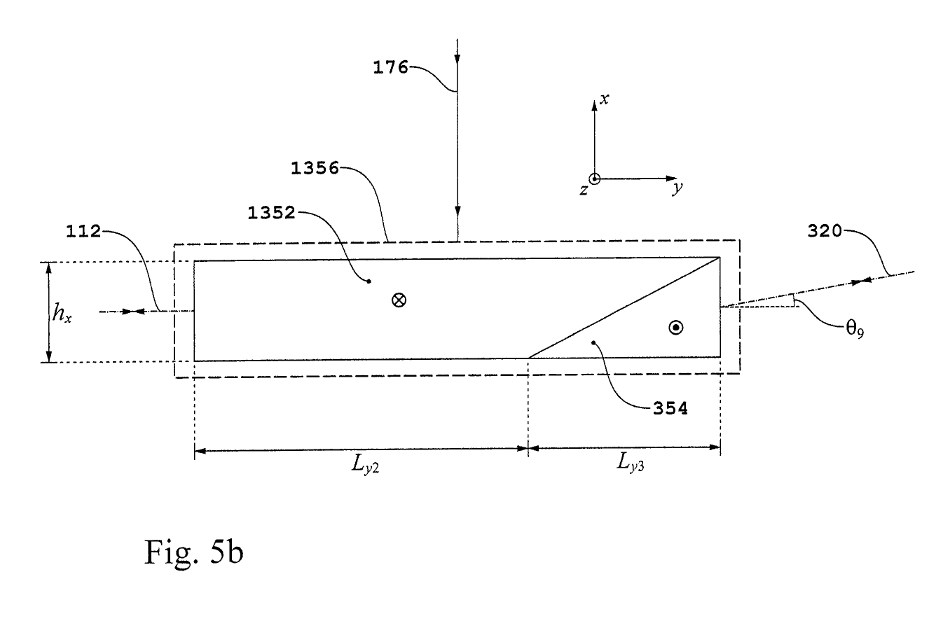

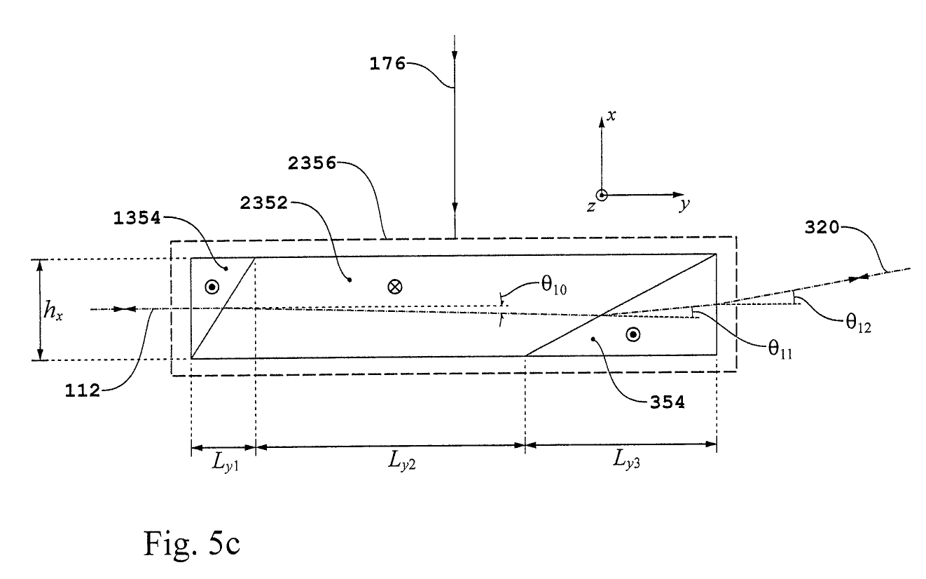

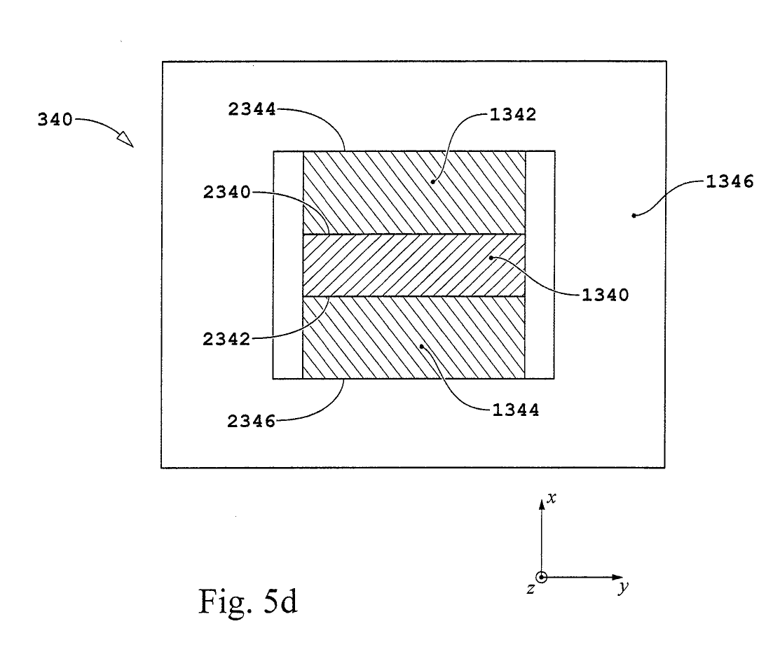

An electro-optic effect modulator configured as a beam-deflector 150 is shown diagrammatically in FIG. 5a. The properties of the electro-optic effect beam-deflector are presented using a z-cut LiNbO₃ crystal as the birefringent medium with the optic axis perpendicular to the plane of FIG. 5a. The path of the optical beam is in the y-direction and the z-axis points into the plane of FIG. 5a. The electro-optic effect modulator comprises two birefringent prism elements 352 and 354 configured as transverse electro-optic effect modulators with the optic axes in the positive and negative z-directions, respectively. The electric field with magnitude E_{z} is applied in the positive z-direction with a voltage applied to electrodes 356. The projected superimposed outlines of electrodes 356 is shown as a dashed line in FIG. 5a wherein the electrodes are located above and below electro-optic elements 352 and 354.

The refractive indices nₓ, n_{y}, and n_{z} of LiNbO₃ for polarization components of an optical beam aligned in the x-, y-, and z-directions, respectively, with the electric field of magnitude E_{z} applied in the positive z-direction are given by the formula

$$\begin{matrix}{n}_{x} = {n}_{o} - \frac{1}{2} {n}_{o}^{3} {r}_{13} {E}_{z} , & ( 12 ) \\ {n}_{y} = {n}_{o} - \frac{1}{2} {n}_{o}^{3} {r}_{13} {E}_{z} , & ( 13 ) \\ {n}_{z} = {n}_{e} - \frac{1}{2} {n}_{e}^{3} {r}_{33} {E}_{z} , & ( 14 )\end{matrix}$$

where nₒ and nₑ are the ordinary and extraordinary indices of refraction for a LiNbO₃ crystal and rᵢⱼ are the linear electro-optic coefficients.

The deviation δθ_{eom,e} introduced by an electro-optic effect modulator for an optical beam propagation in the y-direction and polarized in the y-z plane, i.e., the extraordinarily polarized beam corresponding to beam 320 in FIG. 5a, can be calculated using Snell's law or by considering the changes in phase experienced by different portions of the optical beam. The latter of the two procedures is described in referenced Section 8.6, Yariv and Yeh, op. cit. The results of the calculation are

$$δ {θ}_{eom , e} = {n}_{e}^{3} {r}_{33} {E}_{z} \frac{{L}_{y}}{{h}_{x}} \qquad ( 15 )$$

where L_{y} and hₓ are the length and height, respectively, of prism elements 352 and 354 (see FIG. 5a). Deviation δθ_{eom,e} corresponds to θ₉ in FIG. 5a.

The deviation δθ_{eom,o} introduced by an electro-optic effect modulator for an optical beam propagation in the y-direction and polarized in the x-z plane is calculated by the same procedure with the result

$$δ {θ}_{eom , o} = {n}_{o}^{3} {r}_{13} {E}_{z} \frac{{L}_{y}}{{h}_{x}} . \qquad ( 16 )$$

Electro-Optic Effect Phase-Modulator

The properties of an electro-optic effect modulator configured as a phase-shift modulator are also presented using a z-cut LiNbO₃ crystal without departing from the scope and spirit of the present invention. The change in the optical path length OP_{p,e} of phase-modulator 140 for extraordinarily and ordinarily polarized beams are given by the formulae

$$\begin{matrix}{OP}_{p , e} = - {l}_{p} ( \frac{1}{2} {n}_{e}^{3} {r}_{33} {E}_{z} ) , & ( 17 ) \\ {OP}_{p , o} = - {l}_{p} ( \frac{1}{2} {n}_{o}^{3} {r}_{13} {E}_{z} ) , & ( 18 )\end{matrix}$$

respectively, where lₚ is the length of the birefringent crystal in the y-direction.

It is evident from Eqs. (17) and (18) that electro-optic effect phase-shift modulator can be used birefringent phase-modulator in certain embodiments of the present invention such as used in ellipsometry when nₑ³r₃₃≠nₒ³r₁₃ such as the case with LiNbO₃ (see Table 3 herein).

Listed in Table 3 are values of certain of the linear electro-optic coefficients rᵢⱼ for LiNbO₃, LiTaO₃, and Strontium-Barium Niobate SrₓBa₍₁₋ₓ₎Nb₂O₆ SBN crystals with x=0.60 and x=0.75 that are examples of birefringent crystals that may be used in the electro-optic modulators wherein (T) and (S) indicate low and high frequency values of respective rᵢⱼ. The Curie temperatures for LiNbO₃, SBN x=0.60, and SBN x=0.75 are 1230° C., 75° C., and 56° C., respectively.

The entrance and exit facets of birefringent media with indices of refraction ≳2 such as LiNbO₃ are relatively easy to coat with AR coatings in order to reduce losses in a respective ECDL.

The requirement that the cavity phase error be □1 places constraints on the relative values of the electric field values E_{z,2} and E_{z,3} applied to electro-optic effect modulators 140 and 150, respectively, of the second embodiment as function of the selected wavelength of an ECDL. The corresponding constraints for the Littrow external cavity are given in first order by the formulae

$$[ Ψ Δ λ + \frac{1}{2} ( {n}_{e}^{3} {r}_{33} {L}_{y , 2} ) {E}_{z , 2} ] \frac{1}{{L}_{L}} = + cot {θ}_{i} [ {n}_{e}^{3} {r}_{33} ( \frac{1}{{h}_{x}} ) ] {L}_{y , 3} {E}_{z , 3} , \qquad ( 19 )$$

TABLE 3
Optical And Electro-Optic Properties Of Birefringent Crystals

| | | | r₁₃ | r₃₃ |
|---|---|---|---|---|
| Medium | nₒ | nₑ | (10⁻¹² m/V) | (10⁻¹² m/V) |
| LiNbO₃ | 2.286 | 2.200 | (S) 8.6 | (S) 30.8 |
| | (633 nm) | (633 nm) | | |
| LiTaO₃ | 2.176 | 2.180 | (S) 7.5 | (S) 33 |
| | (633 nm) | (633 nm) | | |
| BSN x = 0.60 | 2.36 | 2.33 | 47 | 235 |
| | (510 nm) | (510 nm) | | |
| BSN x = 0.75 | 2.3117 | 2.2987 | (T) 67 | (T) 1340 |
| | (633 nm) | (633 nm) | | |

$$\begin{matrix}Ψ = ( \frac{\partial {n}_{s}}{\partial λ} {l}_{s} + \frac{\partial {n}_{0}}{\partial λ} {l}_{0} + \frac{\partial {n}_{eom , 2}}{\partial λ} {L}_{y , 2} + \frac{\partial {n}_{eom , 3}}{\partial λ} {L}_{y , 3} ) , \\ where & ( 20 ) \\ Δ λ = λ cot {θ}_{i} [ {n}_{e}^{3} {r}_{33} ( \frac{1}{{h}_{x}} ) ] {L}_{y , 3} {E}_{z , 3} , & ( 21 )\end{matrix}$$

n_{eom,2} and n_{eom,3} are the respective refractive indices for electro-optic effect modulators 140 and 150, respectively. The corresponding constraints are given for the Littman-Metcalf external cavity by the formula

$$\begin{matrix}[ Ψ Δ λ + \frac{1}{2} ( {n}_{e}^{3} {r}_{33} {L}_{y , 2} ) {E}_{z , 2} ] \frac{1}{{L}_{L - M}} = + \frac{cos {θ}_{i}}{( sin {θ}_{i} + sin {θ}_{d} )} [ {n}_{e}^{3} {r}_{33} ( \frac{1}{{h}_{x}} ) ] {L}_{y , 3} {E}_{z , 3} \\ where & ( 22 ) \\ Δ λ = λ \frac{cos {θ}_{i}}{sin {θ}_{i} + sin {θ}_{d}} [ {n}_{e}^{3} {r}_{33} ( \frac{1}{{h}_{x}} ) ] {L}_{y , 1} {E}_{z , 1} . & ( 23 )\end{matrix}$$

Eqs. (19) and (22) simplify to the following formulae:

$$\begin{matrix}{E}_{z , 2} \frac{{L}_{y , 2}}{{L}_{L}} = 2 cot {θ}_{i} {L}_{y , 3} \frac{1}{{h}_{x}} ( 1 - \frac{Ψ λ}{{L}_{L}} ) {E}_{z , 3} , ( Littrow external cavity ) . & ( 24 ) \\ {E}_{z , 2} \frac{{L}_{y , 2}}{{L}_{L - M}} = 2 \frac{cos {θ}_{i}}{( sin {θ}_{i} + sin {θ}_{d} )} {L}_{y , 3} ( 1 - \frac{Ψ λ}{{L}_{L - M}} ) {E}_{z , 3} \cdot ( Littman \text{-} Metcalf external cavity ) . & ( 25 )\end{matrix}$$

The corresponding changes in the value of the selected wavelength Δλ are given by Eqs. (21) and (23). Control signals 172 and 174 are generated by electronic processor and controller 170 according to Eqs. (21), (23), (24), and (25) including higher order terms where required to determine the values of E_{z,2} and E_{z,3} as a function of the selected wavelength of the ECDL.

Performance properties of an ECDL such as tuning range set by considerations other than the tuning range of the diode laser and properties such as response time determined by properties of the electronic processor and controller 170 in driving electro-optic effect modulators 140 and 150 are listed in Table 4 for the example of a Littrow external cavity. The listed values of V₂ in Table 4 correspond to the modulus of applied voltage that causes a change Δλ in selected wavelength and corresponding change δf in selected frequency for a central wavelength of 635 nm. The tuning ranges in frequency and wavelength are equal to 2δf and 2Δλ, respectively. The length of the electro-optic effect modulator in phase modulator 140 is assumed to be 75% of the Littrow cavity length. A thickness of d_{z}=2.0 mm is assumed for the electro-optic modulator crystal in the z-direction for the performance properties listed in Table 4.

The response time τ listed in the sixth column is defined as the average of the rise and fall times required for a change from 10% of the applied voltage to 90% of the applied voltage.

TABLE 4
Performance Properties Of ECDLs Configured With Electro-Optic Effect
Modulators: Littrow External Cavity

| | δf/V | V₂ | δf | Δλ | τ |
|---|---|---|---|---|---|
| Medium | (MHz/volt) | (volts) | (GHz) | (nm) | (n sec) |
| LiNbO₃ | 14.4 | 100 | 1.4 | 0.0019 | 12 |
| | | 400 | 5.8 | 0.0077 | |
| BSN x = 0.60 | 126 | 10 | 1.26 | 0.00167 | 18 |
| | | 40 | 5.0 | 0.0067 | |
| | | 100 | 12.6 | 0.0167 | |
| | | 400 | 50.2 | 0.0670 | |
| BSN x = 0.75 | 732 | 10 | 7.3 | 0.0097 | 39 |
| | | 40 | 29 | 0.039 | |
| | | 100 | 73 | 0.097 | |
| | | 400 | 293 | 0.39 | |

The direction of propagation of output beam 52 of the Littman-Metcalf external cavity will change as a function of the selected wavelength of the respective ECDL. The change in direction of propagation is a consequence of the change in angle of incidence θᵢ on grating 12 generated by beam-deflector 150. The change in direction of propagation of output beam 52 may be compensated with beam-conditioner 180 comprising an EOM beam-deflector of the same type as used in beam-deflector 150.

The effects of changes in the index of refraction of prisms 352 and 354 as the selected wavelength of an external cavity is changed are also secondary to the changes in the OPL of the external cavity introduced by an electro-optic effect modulator used as a phase-shifter. This property is evident by examination of the ratio of the change in the OPL of an external cavity by an electro-optic effect modulator used as a phase-shifter to the change in OPL of the external cavity that results from changes in the index of refraction of the electro-optic effect modulator phase-shifter as the selected wavelength of the external cavity is changed. The ratios of changes are given by the ratios

$$\frac{{OPL}_{j}}{2 {L}_{y , 2} λ ( \frac{\partial {n}_{e}}{\partial λ} )} , \\ j = 1 , 2 , \qquad ( 26 )$$

where j=1 and 2 corresponds to the Littrow and Littman and Metcalf cavity configurations, respectively. Values for the ratios given by Eq. (26) for the example of L_{y,2}=15 mm, ∂nₑ/∂λ=0.176 at 700 nm for OPLⱼ=106 mm are

$$\frac{{OPL}_{j}}{2 {L}_{y , 2} λ ( \frac{\partial {n}_{e}}{\partial λ} )} ≅ 29 , \\ j = 1 , 2. \qquad ( 27 )$$

The effects of changes in the index of refraction of the gain medium 11 of source 10 as the selected wavelength of an external cavity is changed are also secondary to the changes in the OPL of the external cavity introduced by an electro-optic effect modulator used as a phase-shifter. This property is evident on examination of the ratios of the change in the OPL of an external cavity by an electro-optic effect modulator used as a phase-shifter to the change in OPL of the external cavity that results from changes in the index of refraction of the gain medium 11 as the selected wavelength of the external cavity is changed. The ratios of changes are given by the ratios

$$\frac{{OPL}_{j}}{2 {l}_{s} λ ( \frac{\partial {n}_{s}}{\partial λ} )} , \\ j = 1 , 2. \qquad ( 28 )$$

Values for the ratios given by Eq. (28) for the example of OPLⱼ=106 mm, ∂nₛ/∂λ=1.15 at 700 nm and lₛ=0.5 mm for a diode laser source comprising a gain medium of Al(0.30)Ga(0.70)As are

$$\frac{{OPL}_{j}}{2 {l}_{s} λ ( \frac{\partial {n}_{s}}{\partial λ} )} ≅ 132 , \\ j = 1 , 2. \qquad ( 29 )$$

A first variant of the second embodiment of the present invention is described for use when it is desirable to compensate for beam shear at grating 12 such as generated by electro-optic effect beam-deflector 150 in addition to providing an ECDL with high tuning and switching rates. For the first variant of the second embodiment, beam-conditioner 40 comprises phase-modulator 140 and beam-deflectors 130 and 150 in a Littman-Metcalf external cavity. The description of the first variant of the second embodiment is the same as corresponding portions of the second embodiment.

The description of beam-deflector 130 controlled by signal 172 from electronic processor and controller 170 is the same as the corresponding description given for beam-deflector 150 except with respect to the selection of values of \tilde{θ}₁. One condition placed on the selection of the value of \tilde{θ}₁ and \tilde{θ}₂ is that the sum of \tilde{θ}₁ and \tilde{θ}₂ generates a required value of the angle of incidence θᵢ at grating 12 [see Eq. (5)]. The second condition placed on the selection of the values of \tilde{θ}₁ and \tilde{θ}₂ is that the shear of beam 120 at grating 12 is compensated to the level required for an end use application.

A second variant of the second embodiment of the present invention comprises a beam-conditioner 40 such as shown diagrammatically in FIG. 5b that comprises electro-optic elements 354 and 1352 and electrodes 1356. The projected superimposed outlines of electrodes 1356 is shown as a dashed line in FIG. 5b wherein the electrodes are located above and below electro-optic elements 354 and 1352. Beam-conditioner 40 of the second variant of the second embodiment has the same functionality as beam-conditioner 40 the second embodiment. Element 1352 comprises a phase-shifter section of length L_{y2} (see FIG. 5b) and a section corresponding to element 352 of FIG. 5a of length L_{y3}. Element 354 shown in FIG. 3b is the same as element 354 shown in FIG. 3a. The ratio L_{y2}/L_{y3} is selected so that the ratio E_{z2}/E_{z3}=1 for the electric fields given by Eqs. (24) and (25). Electric fields E_{z2} and E_{z3} are generated by a common voltage signal 176 applied to electrodes 1356 that are common to both elements 354 and 1352.

The remaining description of the second variant of the second embodiment is the same as corresponding portions of the description of the second embodiment.

A third variant of the second embodiment of the present invention comprises a beam-conditioner 40 such as shown diagrammatically in FIG. 5c that comprises electro-optic elements 354, 1354, and 2352 and electrodes 2356. The projected superimposed outlines of electrodes 2356 is shown as a dashed line in FIG. 5c wherein the electrodes are located above and below electro-optic elements 354, 1354, and 2352. Beam-conditioner 40 of the third variant of the second embodiment has the same functionality as beam-conditioner 40 of the first variant of the second embodiment. Element 2352 comprises a phase-shifter section of length L_{y2} (see FIG. 5c) and triangular sections of lengths L_{y1} and L_{y3}. The triangular section of length L_{y3} is the same as element 352 of FIG. 5a. The ratios L_{y2}/L_{y1} and L_{y2}/L_{y3} are selected so that the ratios E_{z2}/E_{z1}=E_{z2}/E_{z3}=1 for the electric fields given by Eqs. (24) and (25). Electric fields E_{z1}, E_{z2}, and E_{z3} are generated by a common voltage signal 176 applied to electrodes 2356 that are common to elements 354, 1354, and 2352. The angles of refraction at the interface between elements 1354 and 2352, between elements 2352 and 354, and at the exit facet of element 354 are θ₁₀, θ₁₁, and θ₁₂, respectively.

The remaining description of the third variant of the second embodiment is the same as corresponding portions of the description of the first variant of the second embodiment.

External Cavities Comprising Phase-Shifters and Beam-Deflectors Based On Photoelastic Effect

The optical properties of a medium may be changed by an induced strain tensor S. This is known as the photoelastic effect. The photoelastic effect is also known as the acousto-optic (AO) effect [see p 48 of in J. Xu and R. Stroud, Acousto-Optic Devices: Principles, Design, and Applications, Wiley 1992] because the induced strain can be described as produced by a superposition of propagating acoustic waves, often at ultrasonic frequencies. However, the name photoelastic effect will be used herein in order to reduce the potential for generating confusion that might be otherwise generated by the use of the name AO effect. The potential for confusion is with respect to those embodiments of the present invention that use the photoelastic effect to introduce changes in optical properties of a medium but do not use the acoustic-optic interaction or diffraction such as in the third embodiment herein.

Phase-shifters and beam-deflectors may be based on the photoelastic effect using either an tensile strain, e.g., δx/x, a shear strain, or a combination of the two different strains. Embodiments of the present invention that are based on photoelastic effect modulators may incorporate either type of strain or a combination thereof.

An abbreviation PEM is used in the field of ellipsometry for a photoelastic modulator based on generation of a tensile strain [see for example the article entitled “N ull Ellipsometer With Phase Modulation” by K. Postava, A. Maziewski, T. Yamaguchi, R. Ossikovski, S. Vi\check{s}novský, and J. Pi\check{s}tora, Optics Express 12, p 6040 (2004)]. The PEM with a modulation frequency of typically 50 kHz is used as a birefringent phase modulator in ellipsometry and usually consists of a fused silica bar vibrating at a natural resonant frequency sustained by a piezoelectric transducer. The periodic stress generated by the vibrations creates an optical anisotropy in the silica bar showing a photoelastic effect.

An advantage of the PEM as used in ellipsometry is that it is a time-periodic, single-frequency device assuming it takes the form of a high-Q mechanical resonator. A consequence of the use of a high-Q mechanical resonator is that the PEM is not appropriate for fast-transient or single pulse modulation, outside of the bandwidth limitation of Δf=f/Q where f is the resonant frequency.

For a non-resonant operation, the response time for a photoelastic change in a medium is ultimately limited to the propagation time of sound waves across a required spatial aperture of width d, i.e., to a time d/υ, where υ is a respective longitudinal or shear wave sound speed. The spatial aperture is defined by the transverse spatial properties of an optical beam that is transmitted by the PEM. For a non-resonant operation that uses two longitudinal or shear acoustic wave sources symmetrically located with respect to the aperture, the corresponding response time is d/2υ. For a device based on the acousto-optic interaction or diffraction, the corresponding response time is d/υ which is larger by a factor of two than the response time for the symmetric non-resonant mode PEM.

The photoelastic effect in a medium couples a mechanical strain to the optical index of refraction. This effect is described by

$${[ Δ ( \frac{1}{{n}^{2}} ) ]}_{I} = {p}_{IJ} {S}_{J} , \\ I , J = 1 , 2 , … , 6 , \qquad ( 30 )$$

where [Δ(1/n²)]_{I} is the change in the respective optical impermeability tensor component, S_{J} is the strain component of strain tensor S, and contracted indices are used. The contracted indices I and J are defined as
1=(11),
2=(22),
3=(33),
4=(23)=(32),
5=(13)=(31),
6=(12)=(21). (31)

Higher-order terms involving powers of strain tensor components S_{J} are neglected in Eq. (30) because these terms are usually small compared with the linear term. However, in certain embodiments of the present invention where the non-linear effects represented by the neglected higher-order terms are important, the non-linear effects are measured and subsequently compensated.

Strain tensor S generated by a stress tensor T may be expressed in terms of stress tensor T as
S_{I}=s_{IJ}T_{J}, I,J=1, 2, . . . , 6, (32)
where s_{IJ} is the elastic compliance coefficient matrix element. Information about values of compliance coefficient matrix (s_{IJ}) are given for example in Chapter 33, Tables 11, 12, . . . , and 15 by W. J. Tropf, M. Thomas, and T. J. Harris, The Handbook Of Optics, II, M. Bass, Ed. in Chief, (McGraw-Hill, 1978). The form of the elastic compliance coefficient matrix (S_{IJ}) can be obtained from the elastic stiffness coefficient matrix (cᵢⱼ) which as evident from Eq. (32) is the inverse of elastic compliance coefficient matrix (s_{IJ}). The restrictions on the elastic stiffness matrices (cᵢⱼ) are the same as the restrictions on the photoelastic matrices (P_{IJ}) for the different crystalline classes except for the additional restriction on c_{IJ} that C_{IJ}=c_{JI} as noted in Appendix D, Section D.1, Xu and Stroud, op. cit.

The strain and stresses are generated by piezoelectric transducers attached to one or more facets of the photoelastic medium. In the design of a photoelastic modulator comprising one or more piezoelectric transducers, boundary conditions at the one or more facets are imposed such as the stresses and the displacements of a transducer and photoelastic medium at a common interface are each equal in magnitude and opposite in sign, respectively.

Photoelastic Effect Phase-Shifters

Shown diagrammatically in FIG. 5d is a cross-sectional view of phase-modulator 340 based on the shear photoelastic effect. Phase-modulator 340 comprises photoelastic medium 1340 and piezoelectric transducers 1342 and 1344 bonded together at electrode interfaces 2340 and 2342, respectively. Piezoelectric transducers 1342 and 1344 are bonded to yoke 1346 at electrode interfaces 2344 and 2346, respectively. Voltage signals are applied between electrode interfaces 2340 and 2344 and electrode interfaces 2342 and 2346 to generate electric fields in piezoelectric transducers 1342 and 1344, respectively. The optical beam propagates approximately in the z-axis direction which is to not be confused with the optic axis or z-axis of photoelastic medium 1340.

An example of a piezoelectric medium that can be used for a transducer is a rotated x-cut LiNbO₃ crystal (trigonal system, class 3m) with an electric field of magnitude E₁ pointing in the x-axis direction of the crystal (which also coincides with the x-axis of the coordinate system in FIG. 5d) generated by an applied voltage. The advantage of a x-cut LiNbO₃ crystal is that an electric field applied in the x-axis direction of the crystal introduces only shear strains S₅ and S₆. In addition the x-cut LiNbO₃ crystal can be rotated about the x-axis of the coordinate system of FIG. 5d which is orthogonal to interfaces 2340 and 2342 of photoelastic medium 1340 so that a particular combination of rotated S₅ and S₆ strains is selected as subsequently described herein. In certain embodiments of the present invention, the selected particular combination of rotated S₅ and S₆ strains generate only one non-zero element of the associated change in the optical impermeability tensor of the photoelastic medium, i.e., [Δ(1/n²)]₆. When only element [Δ(1/n²)]₆ is nonzero, the corresponding changes in nₓ and n_{y} are equal in magnitude and opposite in sign. Other examples of piezoelectric media that can also be used with the same described advantages of x-cut LiNbO₃ crystals are different types of lead zirconate titanate (PZT) ceramics and lead magnesium niobate/lead titanate (PMN-PT) crystals. PZT-5, one type of PZT ceramic commercially available, and PMN-PT are of the crystal classes 6 mm (hexagonal system) and 4 mm (tetragonal system), respectively.

An example of shear strains that can be used for the photoelastic media in the case of trigonal system classes 3m, 32, and 3̅m, e.g., LiNbO₃, Al₂O₃, and quartz, are
S^{T}=[0,0,0,0,S₅,S₆]. (33)
where A^{T} is the transpose of tensor A. The corresponding changes in the optical impermeability tensor are
[Δ(1/n²)]=[0,0,0,0,p₅₅S₅+p₅₆S₆,p₆₅S₅+p₆₆S₆]^{T} (34)
For the case of the selection of S₅ and S₆ such that [Δ(1/n²)]₅=0, it is observed from Eq. (34) that strain components S₅ and S₆ are related such that
p₅₅S₅+p₅₆S₆=0 (35)

The resulting optical impermeability tensor when the condition expressed by Eq. (35) is met is

$$[ Δ ( 1 / {n}^{2} ) ] = {[ 0 , 0 , 0 , 0 , 0 , ( \frac{- {p}_{65} {p}_{56} + {p}_{55} {p}_{66}}{{p}_{55}} ) {S}_{6} ]}^{T} . \qquad ( 36 )$$

The corresponding changes Δn_{1′} and Δn_{2′} in the refractive indices are

$$\begin{matrix}Δ {n}_{{1}^{′}} = \frac{1}{2} {n}_{1}^{3} ( \frac{- {p}_{65} {p}_{56} + {p}_{55} {p}_{66}}{{p}_{55}} ) {S}_{6} , & ( 37 ) \\ Δ {n}_{{2}^{′}} = - \frac{1}{2} {n}_{2}^{3} ( \frac{- {p}_{65} {p}_{56} + {p}_{55} {p}_{66}}{{p}_{55}} ) {S}_{6} , & ( 38 )\end{matrix}$$

wherein orthogonal x′ and y′ axes, i.e., axes 1′ and 2′, respectively, are rotated by 45 degrees with respect to x and y axes of the photoelastic crystal. Strain components S₅ and S₆ are generated at common opposing y, z facets of the crystals (interfaces 2340 and 2342 shown in FIG. 5d).

The effective photoelastic coefficient and ratio of strain components S₅ and S₆ specified by the condition expressed by Eq. (35) are

$$\begin{matrix}( \frac{- {p}_{65} {p}_{56} + {p}_{55} {p}_{66}}{{p}_{55}} ) = - 0.136 , & ( 39 ) \\ \frac{{p}_{56}}{{p}_{55}} = - 1.034 , & ( 40 )\end{matrix}$$

respectively, for LiNbO₃ at a wavelength of 633 nm. The corresponding ratio of strain components S₅ and S₆ according to the condition expressed by Eq. (35) is

$$\frac{{S}_{5}}{{S}_{6}} = - \frac{{p}_{56}}{{p}_{55}} = 1.034 . \qquad ( 41 )$$

An example of shear strains that can be used for the photoelastic media in the case of cubic system classes wherein p₄₆=p₅₆=0, e.g., LiF and CaF₂, is given by Eq. (33) with S₅=0. The corresponding changes Δn_{1′} and Δn_{2′} in the refractive indices are

$$\begin{matrix}Δ {n}_{{1}^{′}} = \frac{1}{2} {n}_{1}^{3} {p}_{66} {S}_{6 ,} & ( 42 ) \\ Δ {n}_{{2}^{′}} = - \frac{1}{2} {n}_{2}^{3} {p}_{66} {S}_{6} . & ( 43 )\end{matrix}$$

For the example of LiF, p₆₆=−0.064 at 590 nm. [see Table 1, Chapter 12, The of Handbook of Optics II, op. cit.].

Another example of shear strains that can be used for the photoelastic media in the case of tetragonal system classes 4 mm, 422, 4/mmm wherein p₄₆=p₅₆=0, e.g., crystals of TeO₂ and Hg₂Cl₂, is also given by Eq. (33) with S₅=0. The corresponding changes Δn_{1′} and Δn_{2′} in the refractive indices are given by Eqs. (42) and (43), respectively.

Crystals of TeO₂ and Hg₂C₂ have low values of 616 m/sec and 347 m/sec, respectively, for the speed of a shear wave propagating in the [1,1,0] direction [see Table K.1, Xu and Stroud, op. cit.]. This property can be used in photoelastic modulators advantageously with reduced values of stresses experienced by transducers. This same advantage is also present with respect to transducers in AOMs that comprise crystals of TeO₂ and Hg₂Cl₂.

However, crystals of TeO₂ and Hg₂Cl₂ are also optically active with circularly polarized eigenmodes for optical beams propagating parallel to the optic axes of the crystals. The circularly polarized eigenmodes transform to elliptically polarized eigenmodes when the optical beams propagate at an angle with respect to the optic axis [see Section 1.4, Xu and Stroud, op. cit.]. For example, the ellipticity of the eigenmodes is 0.032 at 633 nm in TeO₂ for a beam propagating at an angle of 10 deg with respect to the optic axis. The design of the photoelastic modulator with an optically active photoelastic media is based on considerations and procedures that are the same as corresponding considerations and procedures described with respect to AOMs in U.S. Pat. No. 6,157,660 entitled “Apparatus for Generating Linearly-Orthogonally Polarized Light Beams” by Henry A. Hill, the contents of which are herein incorporated by reference.

The remaining description of phase-modulators based on the photoelastic effect is the same as corresponding portions of the description given in the second embodiment of the present invention for phase-modulators based on electro-optic effect except with respect to the response time. The response time for phase-modulators based on the photoelastic effect is determined by the acoustic resonant properties of the photoelastic medium and the associated transducers.

Photoelastic Effect Beam-Deflectors

The description of photoelastic effect beam-deflector is the same as the corresponding portion of the description given herein in the Section entitled “Electro-Optic Effect Beam-Deflector” wherein the changes in the optical properties, i.e., changes in the optical impermeability tensor, are introduced by applied mechanical strains instead of by applied electric fields.

For each of the second embodiment and variants thereof of the present invention, there are other variants thereof wherein the electro-optic phase modulators and beam-deflectors of the second embodiment and variants thereof are replaced with photoelastic phase modulators and beam-deflectors.

Acousto-Optic Diffraction Beam-Deflectors

The third embodiment of the present invention is described with beam-deflectors based on acousto-optic diffraction. Reference is made to Section 10.2.1 entitled “Birefringent Acousto-Optic Beam Deflection” in referenced book by Yariv and Yeh, op. cit., for a discussion of acousto-optic modulators used as optical beam-deflectors.

The difference in directions of propagation δₐ of a diffracted and non-diffracted optical beam by an AOM is equal to the ratio of the wavelength λ of optical beam and the acoustic wavelength Λₐ of the acoustic beam used in the AOM, i.e.,

$${δ}_{a} = \frac{λ}{{Λ}_{a}} . \qquad ( 44 )$$

The angle δₐ can beneficially be written in terms of the frequency fₐ and speed uₐ of the acoustic beam as

$${δ}_{a} = \frac{λ}{{u}_{a}} {f}_{a} . \qquad ( 45 )$$

The values uₐ for the pure shear acoustic wave propagating in the [110] plane of a TeO₂ crystal is approximately 620 m/sec (see Section 1.6 entitled “Acoustic Properties of TeO₂ and PbMoO₄” in J. Xu and R. Stroud, Acousto-Optic Devices: Principles, Design, and Applications, Wiley 1992). Typical values of a shear acoustic wave in other crystals such as LiNbO₃ are approximately 4 km/sec and typical values of longitudinal acoustic waves are less than or of the order of 6 km/sec.

The ratio of change in tuning frequency δfₒ to the change in acoustic beam frequency δfₐ is for an AOM used as a beam-deflector is given by the formula

$$\begin{matrix}\frac{δ {f}_{o}}{δ {f}_{a}} = \frac{c}{{u}_{a}} \frac{1}{tan {ϑ}_{i}} ( Littrow external cavity ) . & ( 46 ) \\ \frac{δ {f}_{o}}{δ {f}_{a}} = \frac{c}{{u}_{a}} ( \frac{cos {ϑ}_{i}}{sin {ϑ}_{i} + sin {θ}_{d}} ) ( Littman \text{-} Metcalf external cavity ) . & ( 47 )\end{matrix}$$

where c is the free space speed of light. The response time τ is defined as the time required for a change in 10% of the intensity of an optical beam to be diffracted to 90% of the intensity of the optical beam to be diffracted which is related to the time for a wavefront of an acoustic beam to cross the optical beam. The response time τ for the AOM beam-deflector and an optical beam that has a Gaussian intensity distribution in the direction of propagation of the diffracting acoustic beam is given by the formula

$$τ = \frac{1.28}{1.41} ( \frac{w}{{u}_{a}} ) = 0.908 ( \frac{w}{{u}_{a}} ) \qquad ( 48 )$$

where w is the (1/e)² width (intensity) of the optical beam in the direction of propagation of the diffracting acoustic beam. The response time is related to the access time used in discussions of acousto-optic beam-deflectors [see Section 10.2 of Yariv and Yeh op. cit.].

There are a set of equations applicable to an external cavity with AOMs used as beam-deflectors that correspond to Eqs. (19) and (22) where EOMs are used as beam-deflectors. The corresponding set of equations is obtained from Eqs. (19) and (22) by substituting on the right hand side of the equations

$$\begin{matrix}{n}_{e}^{3} {r}_{33} ( \frac{1}{{h}_{x}} ) {L}_{y , 3} {E}_{z , 3} = \frac{λ}{{u}_{a , 3}} {f}_{a , 3} , \\ where & ( 49 ) \\ {δ}_{a , 3} = \frac{λ}{{u}_{a , 3}} {f}_{a , 3} , & ( 50 )\end{matrix}$$

and δ_{a,3}, u_{a,3}, and f_{a,3} are the angle, acoustic beam speed, and frequency of acoustic beam for beam-deflector 150 configured as an AOM beam-deflector. The equations of the set of equations corresponding to Eqs. (19) and (22) are the equations including higher order terms where required that are used by electronic processor and controller 170 to generate control signal 176 to determine the value of f_{a,3} as a function of the selected wavelength of the ECDL. The equations of the set of equations corresponding to Eqs. (19) and (22) are the equations including higher order terms where required that are used to determine change in the value Δλ of the selected wavelength for given changes in f_{a,3}.

In the second embodiment of the present invention, beam-deflector 150 was described as comprising a single EOM. In the third embodiment beam-deflector 150 is also fabricated as a single AOM. Alternatively, a phased array transducer may also be used in the AOM beam-deflector to maintain the diffraction efficiency of beam-deflector 150 such as described in Section 6.5 entitled “The Design of Birefringent Devices with Phased Array Transducers”, J. Xu and R. Stroud, op. cit.

The polarization state of an optical beam in a polarization eigenmode state is rotated by π/2 rad when using anisotropic Bragg diffraction in beam-deflectors which corresponds to the case where a birefringent media is used in the AOM. In particular, the polarization state of the diffracted optical beam is orthogonal to the polarization state of the input and non-diffracted optical beams. This property will impact on the orientation of the source with respect to other components of an ECDL comprising an AOM beam-deflector with birefringent media and/or on the number of AOM units used in a particular ECDL design.

The product of the tuning range 2δfₒ and 1/τ is independent of the acoustic speed and is obtained by combining Eqs. (46), (47), and (48) with the results

$$\begin{matrix}\frac{δ {f}_{o}}{τ} ≅ \frac{2}{0.908} ( \frac{c}{w} ) ( \frac{1}{tan {ϑ}_{i}} ) ( Littrow external cavity ) , & ( 51 ) \\ \frac{δ {f}_{o}}{τ} ≅ \frac{2}{0.908} ( \frac{c}{w} ) ( \frac{cos {ϑ}_{i}}{sin {ϑ}_{i} + sin {θ}_{d}} ) ( Littman \text{-} Metcalf external cavity ) . & ( 52 )\end{matrix}$$

The diffraction efficiency of for example an AOM with a TeO₂ configured for the pure shear mode in the [110] plane can be high for |δfₐ/fₐ|≲0.1 for AOMs such as the AOMs described in referenced U.S. Pat. No. 6,157,660. For the AOM using a TeO₂ crystal configured for the pure shear mode in the [110] plane, an optical beam width w=0.6 mm, fₐ=50 MHz, θᵢ=60 deg, θ_{d}=0 deg, and |δfₐ/fₐ|≲0.1, the corresponding values for the tuning range 2δfₒ with the assumption that the corresponding changes in the optical path are generated by either an EOM or photoelastic modulator described herein with respect to second embodiment, variants thereof, and/or other variants thereof and access time or response time are obtained using Eqs. (46) and (48) are accordingly
2δfₒ≲28,000 GHz (Littrow and Littman-Metcalf cavities), (53)
τ≅0.9 μsec. (54)
The corresponding values for tuning range 2δfₒ and access time or response time for a shear wave speed uₐ=4 km/sec are
2δfₒ≲4,300 GHz (Littrow and Littman-Metcalf cavities), (55)
τ≅0.14 μsec. (56)

The direction of propagation of output beam 52 of the Littman-Metcalf external cavity will change as a function of the selected wavelength of the respective ECDL. The change in direction of propagation is a consequence of the change in angle of incidence θᵢ on grating 12 generated by beam-deflectors 130 and 150. The change in direction of propagation of output beam 52 may be compensated with beam-conditioner 180 comprising an AOM beam-deflector of the same type as used in beam-deflectors 130 and 150.

Beam-conditioners 180 for third embodiment as well as for the first and second embodiments of the present invention may comprise in addition to a gain medium to amplify the intensities of output beams 50 and 52 AOMs to generate beams 60 and 62 with two frequency components that are orthogonally polarized such as described in referenced U.S. Pat. No. 6,157,660.

The output beam 52 of the Littrow or Littman-Metcalf external cavitys may be generated for certain end use applications comprising two frequency components by square wave modulating or switching the frequency of the ECDL between two sets of values.

Monolithic External Cavity Elements

A first variant of the second embodiment of the present invention is disclosed wherein the beam-conditioner 40 comprises a single monolithic structure shown diagrammatically in FIG. 5b.

Monolithic Beam-Conditioner And Grating

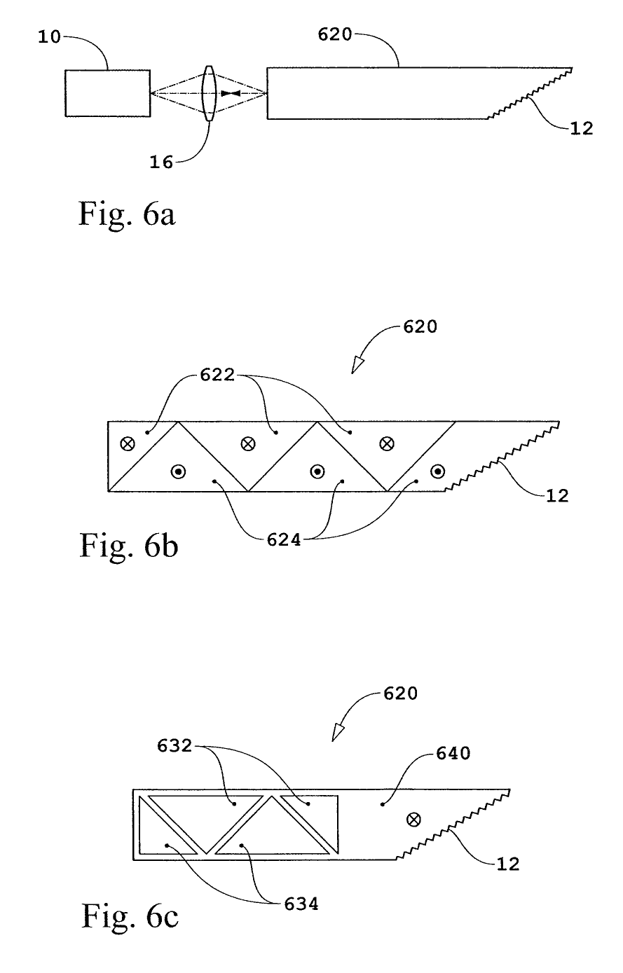

Another variant of the second embodiment and variants thereof are disclosed wherein the external cavity is of the Littrow cavity type and comprises a single monolithic structure shown diagrammatically in FIG. 6a. The single monolithic structure comprises a single birefringent crystal element 620, e.g., LiNbO₃, source 10, and beam forming optics 16. The single monolithic birefringent crystal element 620 and beam forming optics are designed so that the single monolithic birefringent crystal element 620 functions as a slab waveguide for the intra-cavity optical beam. The thickness of the slab waveguide in a direction perpendicular to the plane of FIG. 6a may be of the order of 100μ. Grating 12 is formed on a facet by birefringent crystal element 620 by the known practice of replication.

For the case where grating 12 is formed on monolithic birefringent crystal element 620, the grating equation given by Eq. (2) must be modified to include the effect of the index of refraction of element 620 adjacent to grating 12. The modification is achieved by multiplying the right side of Eq. (2) by the index of refraction of element 620 adjacent to grating 12.

Three different techniques are described for the fabrication of EOM beam-deflector sections in single monolithic crystal element 620. With reference to FIG. 6b, element 620 is fabricated for one of the three different techniques by optical contacting elements 622 in between elements 624. The z-axes of elements 622 are directed into FIG. 6b and z-axes of elements 624 are directed out of FIG. 6b. Electrodes are placed over the sections of element 620 containing the interfaces of elements 622 and 624.

With reference to FIG. 6c, element 620 is fabricated for the second of the three different techniques by segmenting the electrodes as triangle shaped electrodes 632 and 634 on the surfaces of birefringent crystal element 620 such as shown in FIG. 6c and alternating the sign of the voltages between electrodes 632 and 634. Element 620 comprises a single of birefringent crystal element with the z axis directed into the plane of FIG. 6c.

For the third technique of the three different techniques, element 620 is fabricated using domain poling techniques to create a pattered ferroelectric domain structure such as described by C. Baron, H. Cheng, and M. C. Gupta, “Domain Inversion in LiTaO₃ and LiNbO₃ by Electric-Field Application on Chemically Patterned Crystals,” in Appl. Phys. Lett. 68, pp 481-483 (1996). Poling techniques are also described by K. T. Gahagan, D. A. Scrymgeour, J. L. Casson, V. Gopalan, and J. M. Robinson, “Integrated High-Power Electro-Optic Lens and Large-Angle Deflector,” Applied Optics 40, pp 5638-5642 (2001) and references therein. Domain poling techniques can also be used to fabricate the beam deflectors shown in FIGS. 5a, 5b, and 5c.

The voltages required to drive the EOMs of the variant of the second embodiment are reduced by a factor of the order of 25 compared to that of the second embodiment because of the reduced thickness of the monolithic birefringent crystal element 620. Advantage of the reduction of the voltage required to drive the EOMs by a factor of the order of 30 may beneficially used to operate at a corresponding reduced drive voltages to achieve a given tuning range or used to increase the tuning ranges listed in Table 3 by a factor order of 30. For the example of element 620 comprising a LiNbO₃ birefringent medium, the corresponding tuning ranges of voltages V=33 volts and V=100 volts are
2δf≈180 GHz, (57)
2δf≈540 GHz, (58)
respectively, as compared to tuning ranges of 2δf=7.1 GHz and 2δf=21.6 GHz, respectively.

Other embodiments are within the following claims.

What is claimed is:

1. An external cavity structure comprising:
a light source for generating a light beam;
a dispersive system which in combination with the light source defines a cavity, said dispersive system for directing a selected wavelength of the light beam back into the light source, said dispersive system including a grating for selecting said wavelength of the light beam; and
a beam-conditioner positioned within the cavity along a light path between the light source and the dispersive system, said beam conditioner including a beam deflecting element for changing the direction of propagation of the light beam as that light beam that travels between the light source and the dispersive system.

2. The external cavity structure of claim 1, wherein the grating is a diffraction grating.

3. The external cavity structure of claim 1, wherein the beam deflecting element is for changing the angle of incidence of the light beam onto an element of the dispersive system.

4. The external cavity structure of claim 1, wherein the light source and the dispersive system form a Littman-Metcalf type external cavity configuration.

5. The external cavity structure of claim 1, wherein the light source and the dispersive system form a Littrow type external cavity configuration.

6. The external cavity structure of claim 1, wherein the beam-conditioner further comprises a phase modulator for shifting the phase of the light beam that travels between the light source and the dispersive system.

7. The external cavity structure of claim 6, further comprising a control module for controlling the phase modulator.

8. The external cavity structure of claim 1, wherein the grating is a reflective grating.

9. The external cavity structure of claim 1, wherein the dispersive system further comprises a reflecting element located at a distance from the grating and which is arranged to cooperate with the grating to select said wavelength.

10. The external cavity structure of claim 1, wherein the dispersive system has an orientation and position that remain fixed during operation of the external cavity structure.

11. The external cavity structure of claim 1, further comprising a control module for controlling the beam deflecting element to change the angle of incidence of the light beam onto an element of the dispersive system.

12. The external cavity structure of claim 1, further comprising beam forming optics aligned with the light source for collimating the light beam.

13. The external cavity structure of claim 1, wherein the light source is a coherent light source.

14. The external cavity structure of claim 13, wherein the light source comprises a diode laser.

15. The external cavity structure of claim 13, further comprising a control module for changing a wavelength profile of the output of the diode laser.

16. The external cavity structure of claim 13, further comprising a control module for changing an injection current of the diode laser so as to change the wavelength profile of the output of the diode laser.

17. The external cavity structure of claim 1, further comprising a control module for controlling operation of the beam conditioner.

18. The external cavity structure of claim 1, wherein the beam deflecting element comprises an acousto-optic effect modulator.

19. The external cavity structure of claim 1, wherein the beam deflecting element comprises an electro-optic effect modulator.

20. The external cavity structure of claim 1, wherein the phase modulator comprises an electro-optic effect modulator.

21. The external cavity structure of claim 1, wherein the beam deflecting element comprises a photoelastic effect modulator.

22. The external cavity structure of claim 1, wherein the phase modulator comprises a photoelastic effect modulator.

23. A method of operating an external cavity structure that includes a light source and a dispersive system, said method comprising:
at the light source, generating a light beam;
sending the light beam along a path from the light source to the dispersive system;
at the dispersive system, selecting a particular wavelength of the light beam;
directing that selected wavelength back into the light source; and
changing the direction of propagation of the light beam as that light beam that travels along said path between the light source and the dispersive system.

24. The method of claim 23, wherein changing the direction of propagation of the light beam comprises modulating the direction of the light beam to change the selected wavelength.

25. The method of claim 23, further comprising modulating the phase of the light beam as that light beam that travels along said path between the light source and the dispersive system.
